(19) United States
(12) Patent Application Publication
(10) Pub. No.: US 2022/0024314 A1
(43) Pub. Date: Jan. 27, 2022

(54) DISPLAY DEVICE AND NON-TRANSITORY COMPUTER-READABLE STORAGE MEDIUM FOR DISPLAY CONTROL ON HEAD-UP DISPLAY

(71) Applicant: DENSO CORPORATION, Kariya-city (JP)

(72) Inventors: Akihiko YAGYU, Kariya-city (JP); Daisuke TAKEMORI, Kariya-city (JP); Yasuhiro SHIMIZU, Kariya-city (JP); Kazuki KOJIMA, Kariya-city (JP); Shiori MANEYAMA, Kariya-city (JP)

(21) Appl. No.: 17/494,031

(22) Filed: Oct. 5, 2021

Related U.S. Application Data
(63) Continuation of application No. PCT/JP2020/010090, filed on Mar. 9, 2020.

(30) Foreign Application Priority Data
Apr. 9, 2019 (JP) 2019-074329
Mar. 5, 2020 (JP) 2020-038069

(51) Int. Cl. B60K 35/00

(52) U.S. Cl. CPC B60K 35/00; B60K 2370/1868; B60Y 2400/92; B60K 2370/166; B60Y 2300/12; B60K 2370/1529

(57) ABSTRACT

In a display control for a head-up display of a vehicle, offset information is acquired from a lane keeping control unit that controls the vehicle to travel within a subject vehicle lane on which the vehicle travels. The offset information indicates an offset control to move a traveling position from a center portion of the subject vehicle lane to one of right and left sides. Based on the offset information, an offset content indicating fulfillment of the offset control is superimposedly displayed on a road surface in a foreground.

### CROSS REFERENCE TO RELATED APPLICATIONS

The present application is a continuation application of International Patent Application No. PCT/JP2020/010090 filed on Mar. 9, 2020, which designated the U.S. and claims the benefit of priority from Japanese Patent Application No. 2019-074329 filed on Apr. 9, 2019 and Japanese Patent Application No. 2020-038069 filed on Mar. 5, 2020. The entire disclosures of all of the above applications are incorporated herein by reference.

### TECHNICAL FIELD

The present disclosure relates to a display control device and a non-transitory computer-readable storage medium to control display on a head-up display.

### BACKGROUND

For example, there is known a travel control apparatus that automatically generates a track of changing lanes and automatically guides a subject vehicle to the destination of the changed lane according to the generated track. The travel control apparatus superimposes a guidance display indicating positions to start or stop changing lanes based on the automatic guidance on a real image generated from a view captured in front of the subject vehicle and displays the image on display instruments such as a meter and a navigation system.

### SUMMARY

The present disclosure describes a display control device and a non-transitory computer-readable storage medium storing instructions for display control on a head-up display of a vehicle, which are capable of reducing user's discomfort with an offset control and increasing the user convenience. For example, offset information is acquired from a lane keeping control unit that controls the vehicle to travel within a subject vehicle lane on which the vehicle travels. The offset information indicates an offset control to move a traveling position from a center portion of the subject vehicle lane to one of right and left sides. Based on the offset information, an offset content indicating fulfillment of the offset control is superimposedly displayed on a road surface in a foreground.

### BRIEF DESCRIPTION OF DRAWINGS

Features and advantages of the present disclosure will become more apparent from the following detailed description made with reference to the accompanying drawings, in which:

FIG. 1 is a diagram illustrating an overview of an onboard network including HCU according to a first embodiment of the present disclosure;

FIG. 2 is a diagram illustrating a head-up display mounted on a vehicle;

FIG. 3 is a diagram schematically illustrating the contents of offset control provided by a lane keeping control unit;

FIG. 4 is a diagram illustrating a schematic configuration of HCU;

FIG. 5 is a diagram visually illustrating simulation of a display layout provided by a display generation unit;

FIG. 6 is a diagram illustrating a normal display under center keeping control provided by the lane keeping control unit;

FIG. 7 is a diagram illustrating an offset announcement display when an offset notification starts outside an angle of view;

FIG. 8 is a diagram illustrating an offset start display to notify that the offset control starts;

FIG. 9 is a diagram illustrating an offset stop display to notify that the offset control stops;

FIG. 10 is a flowchart illustrating in detail a display control process along with

FIG. 11;

FIG. 11 is a flowchart illustrating in detail a display control process along with

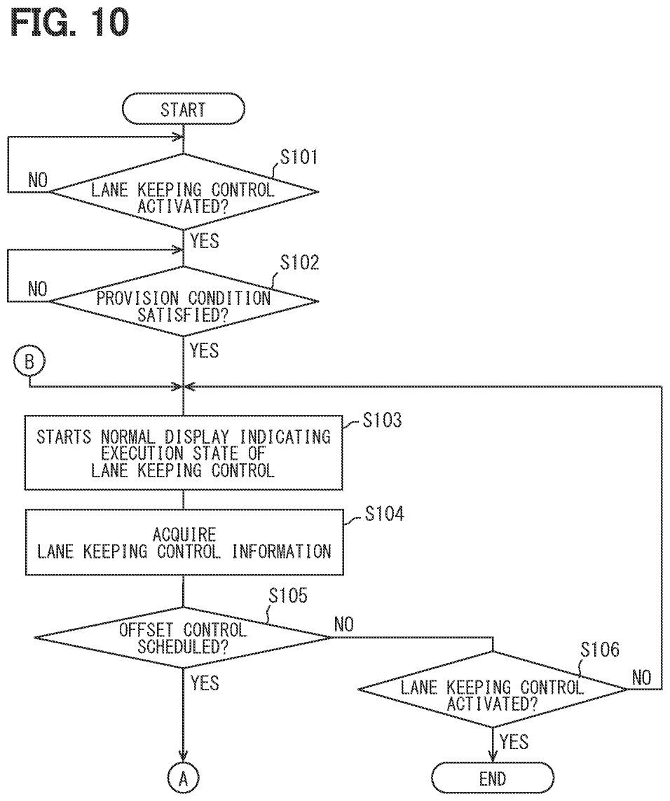

FIG. 10;

FIG. 12 is a diagram illustrating a normal display according to a second embodiment;

FIG. 13 is a diagram illustrating an offset announcement display according to the second embodiment;

FIG. 14 is a diagram illustrating a transition display from the offset announcement display to the offset start display;

FIG. 15 is a diagram schematically illustrating an offset start display according to the second embodiment;

FIG. 16 is a diagram illustrating in detail a display shape of offset content in the offset start display illustrated in FIG. 15;

FIG. 17 is a diagram schematically illustrating an offset stop display according to the second embodiment;

FIG. 18 is a diagram illustrating in detail a display shape of offset content in the offset stop display illustrated in FIG. 17;

FIG. 19 is a diagram illustrating simulation of a display layout to perform the offset start display;

FIG. 20 is a diagram illustrating simulation of a display layout to perform the offset stop display;

FIG. 21 is a diagram illustrating an offset display according to a third embodiment;

FIG. 22 is a diagram illustrating an offset announcement display according to a fourth embodiment;

FIG. 23 is a diagram illustrating an offset start display according to the fourth embodiment;

FIG. 24 is a diagram illustrating an offset stop display according to the fourth embodiment;

FIG. 25 is a diagram illustrating an offset announcement display according to a fifth embodiment;

FIG. 26 is a diagram illustrating an offset start display according to the fifth embodiment;

FIG. 27 is a diagram illustrating an offset display according to a sixth embodiment;

FIG. 28 is a diagram illustrating a normal display according to the sixth embodiment;

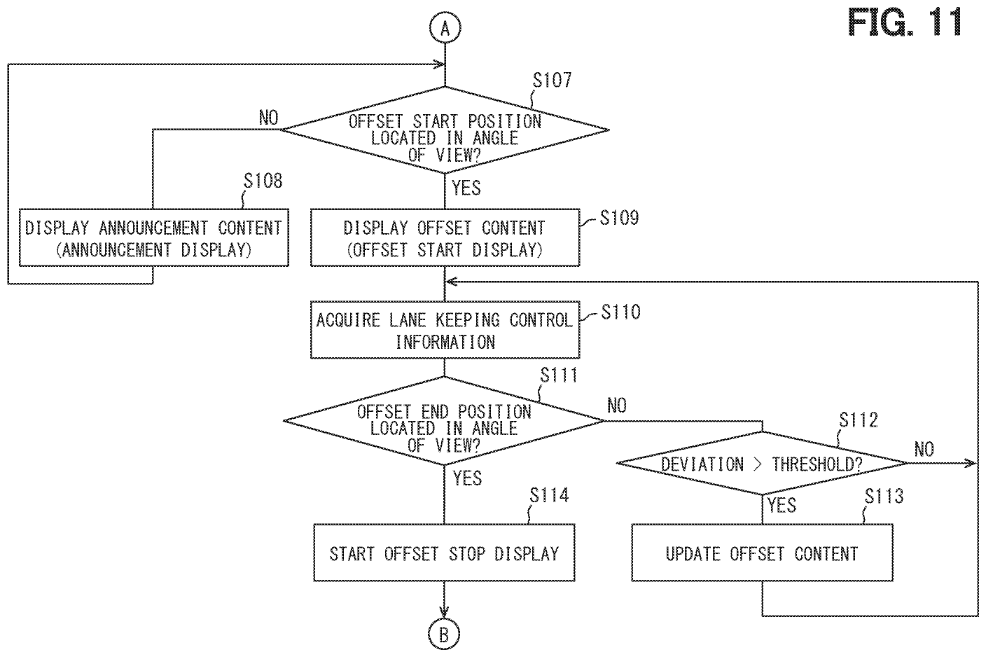

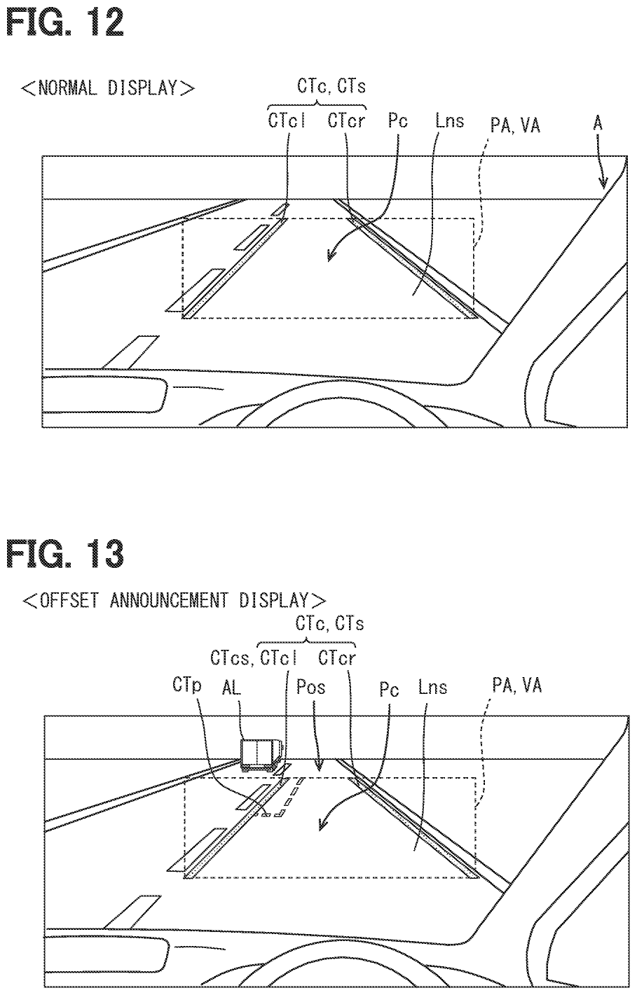

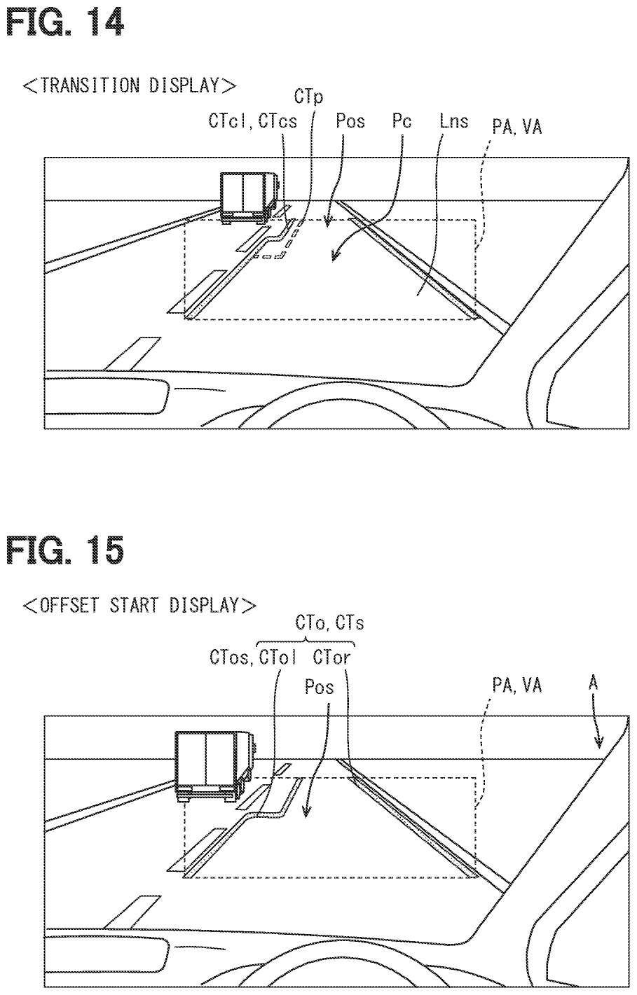

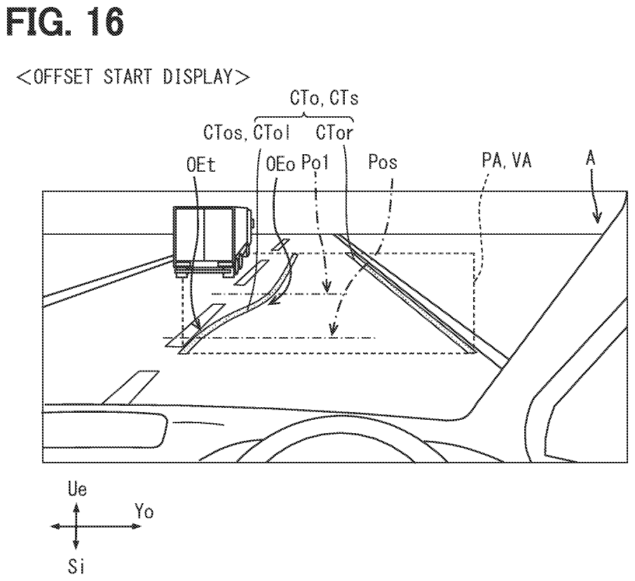

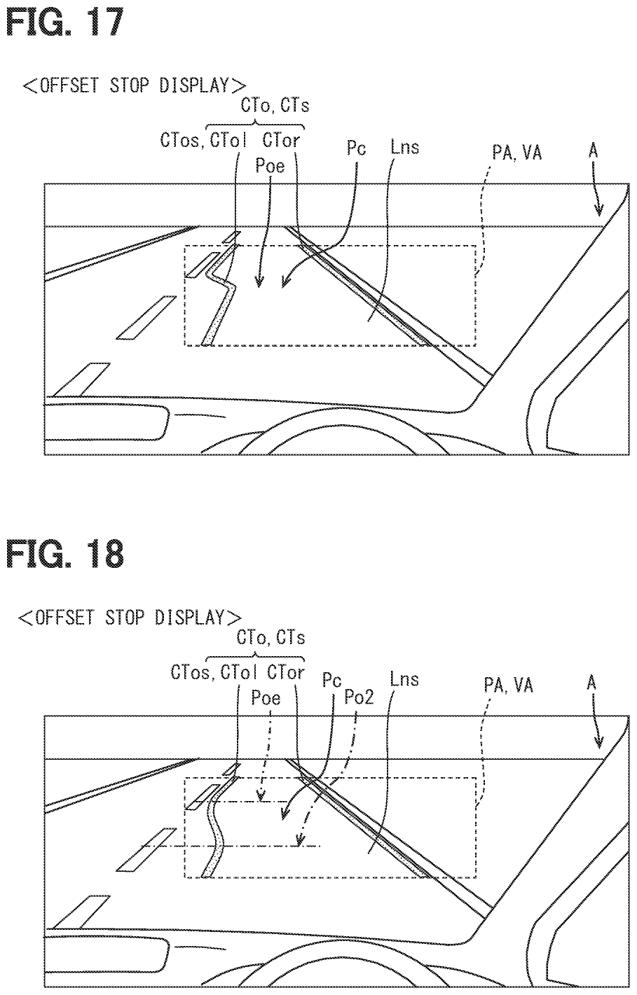

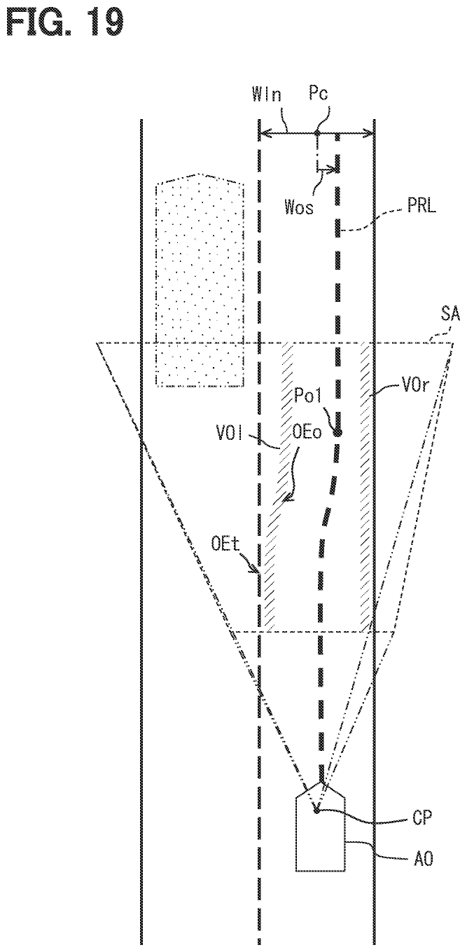

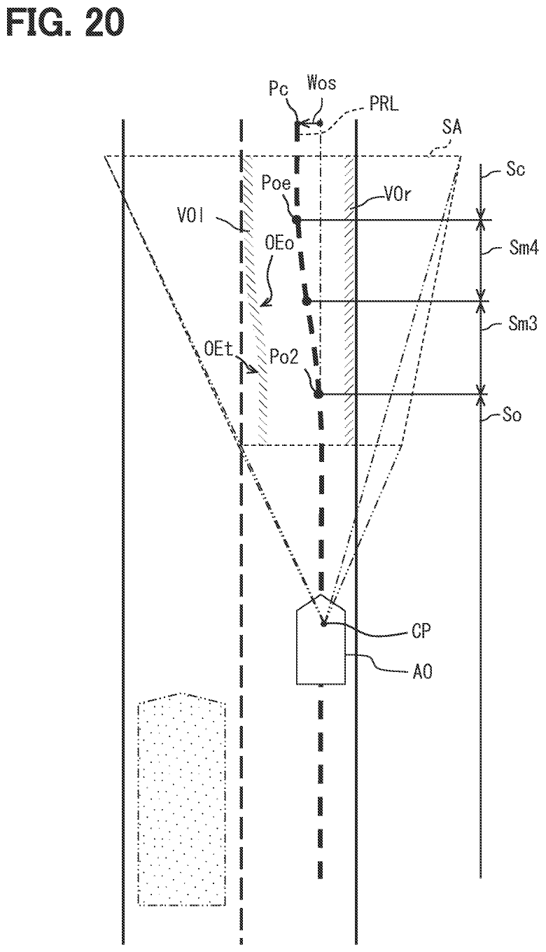

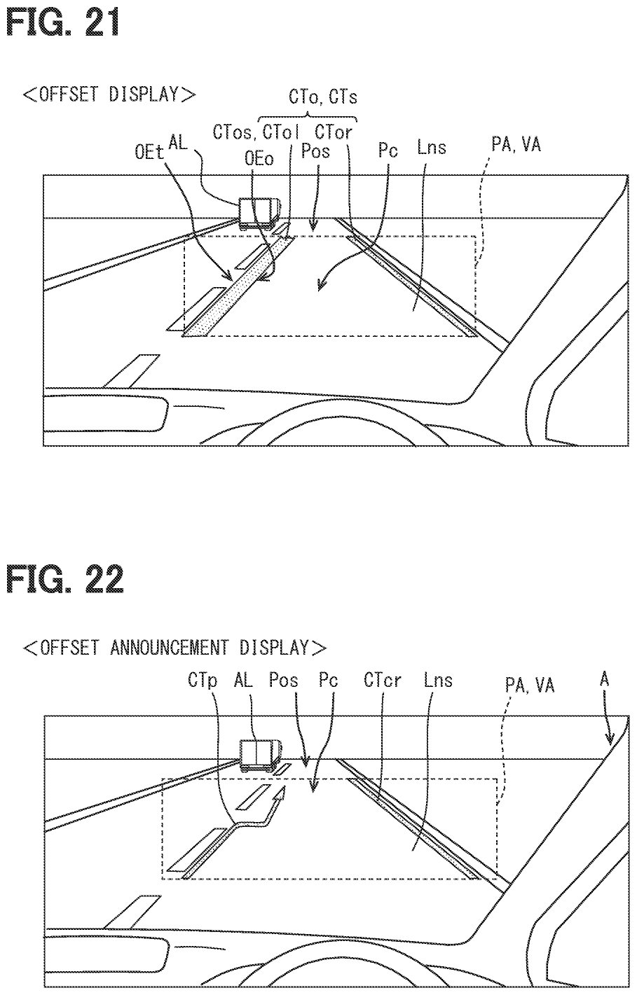

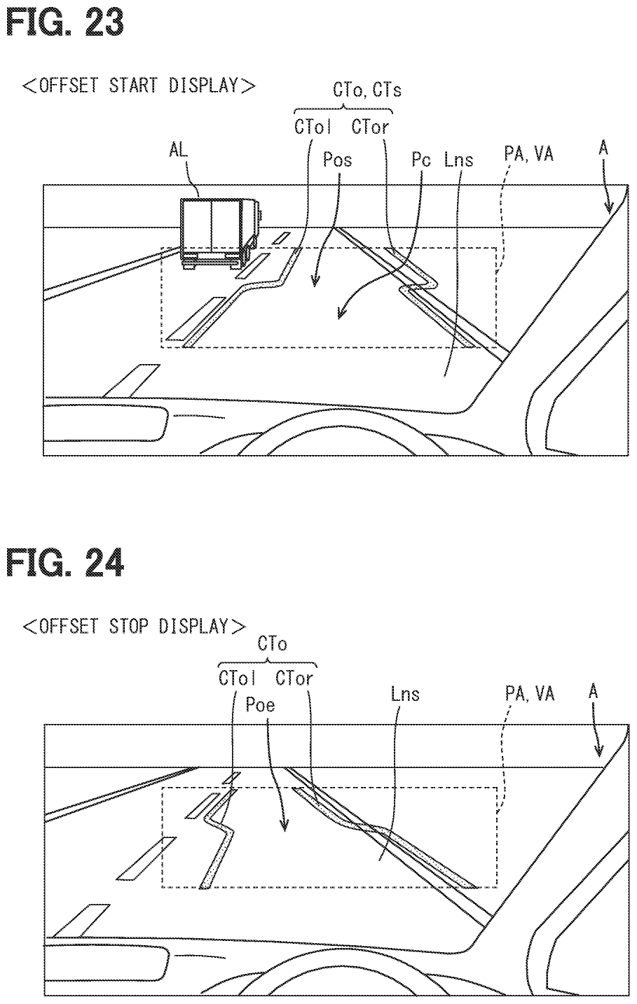

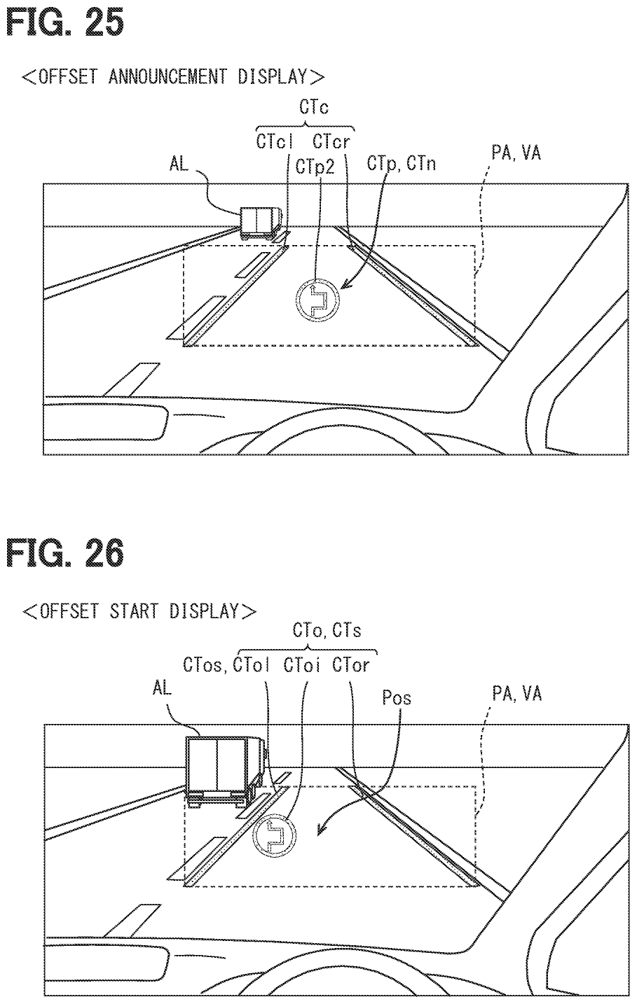

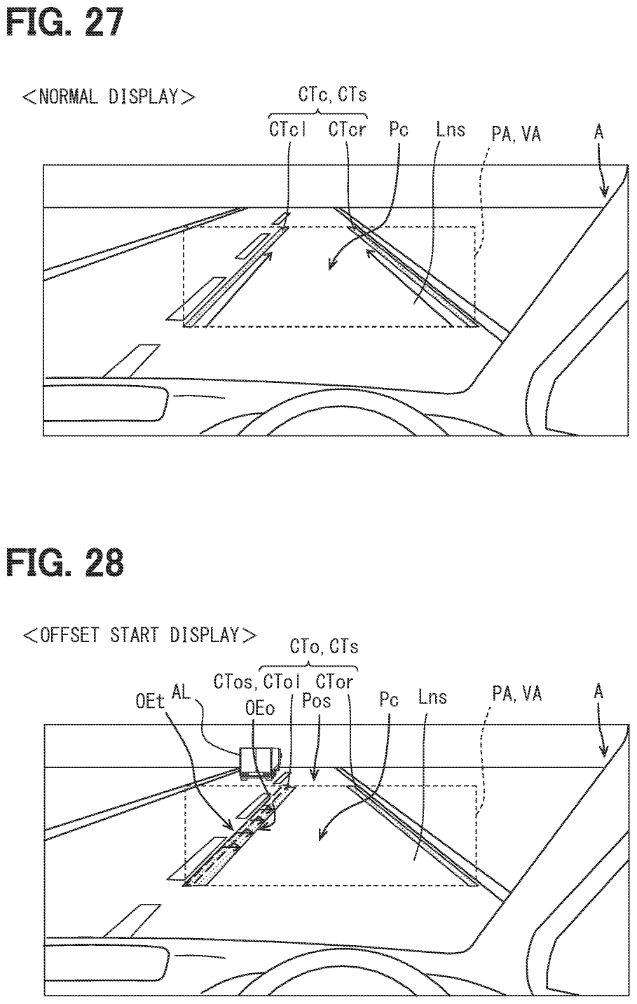

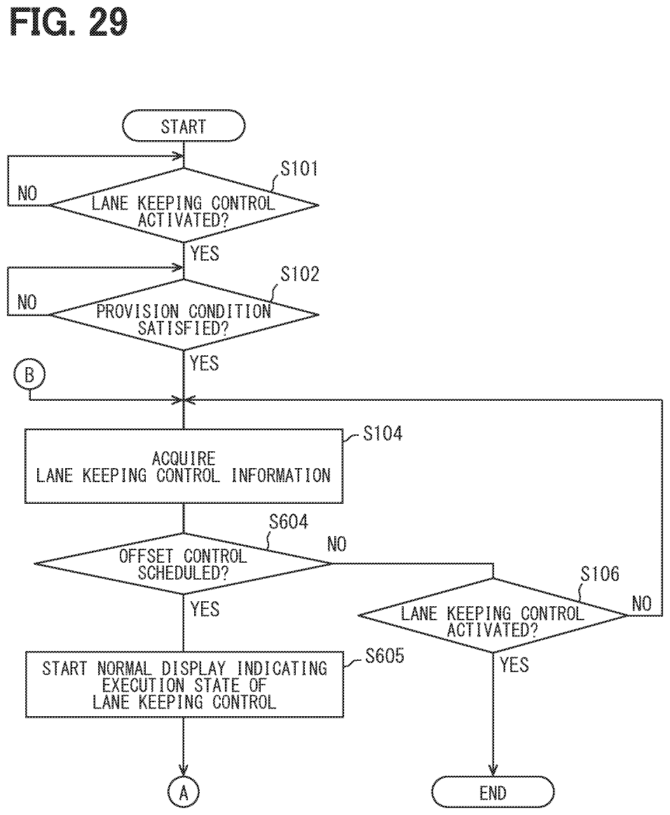

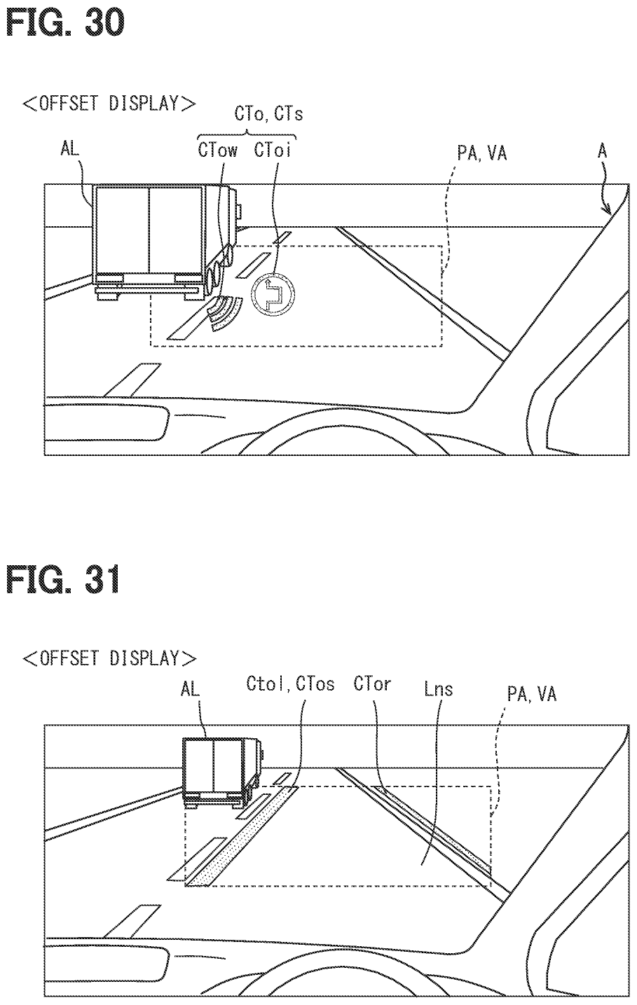

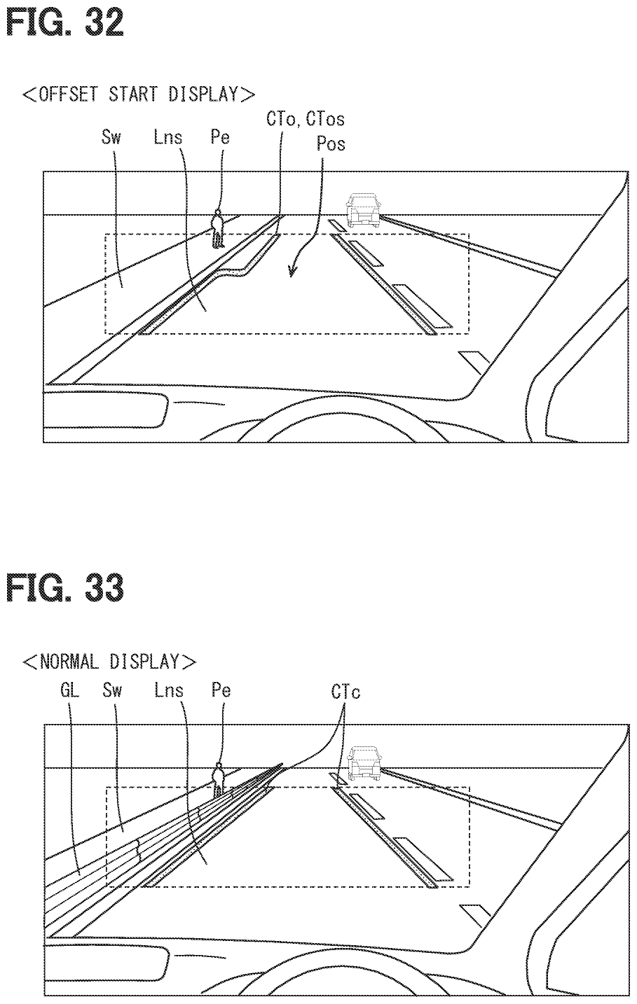

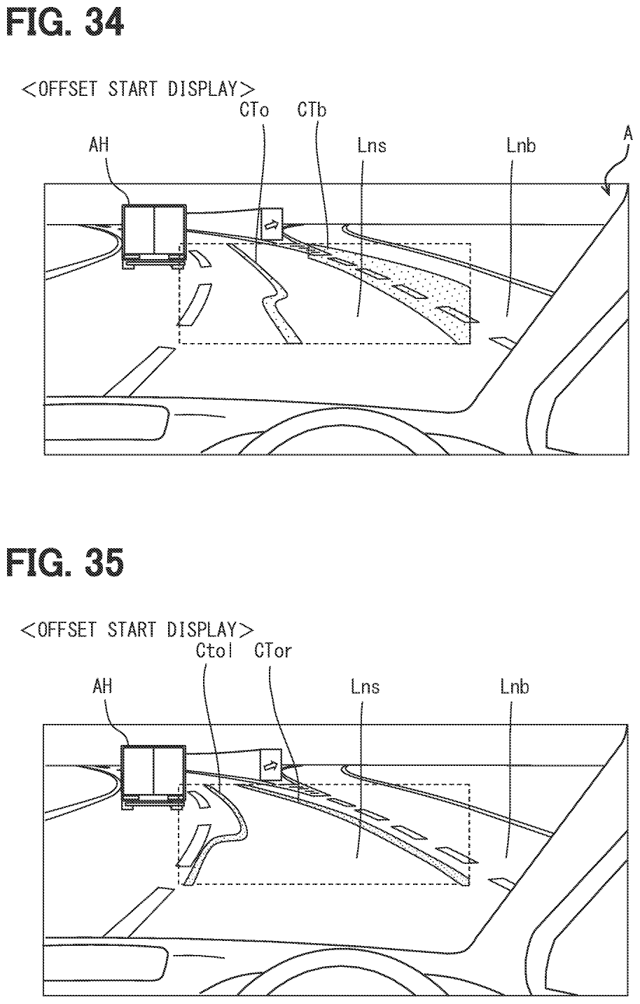

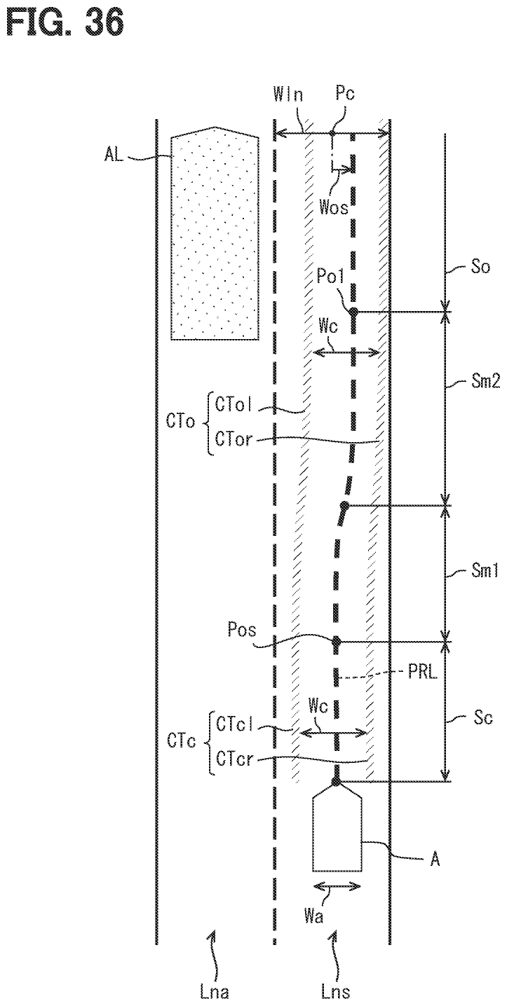

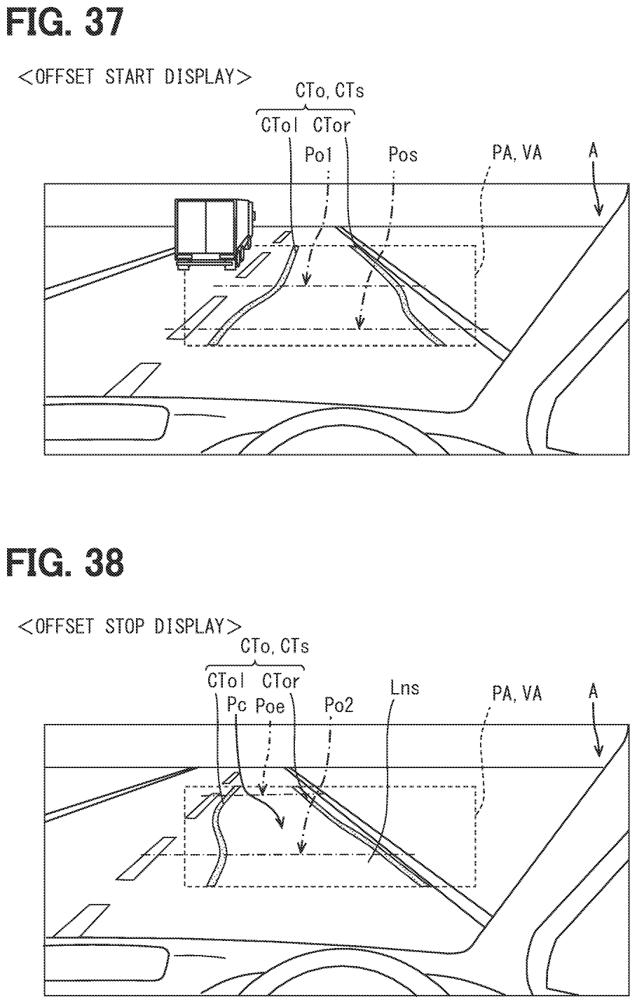

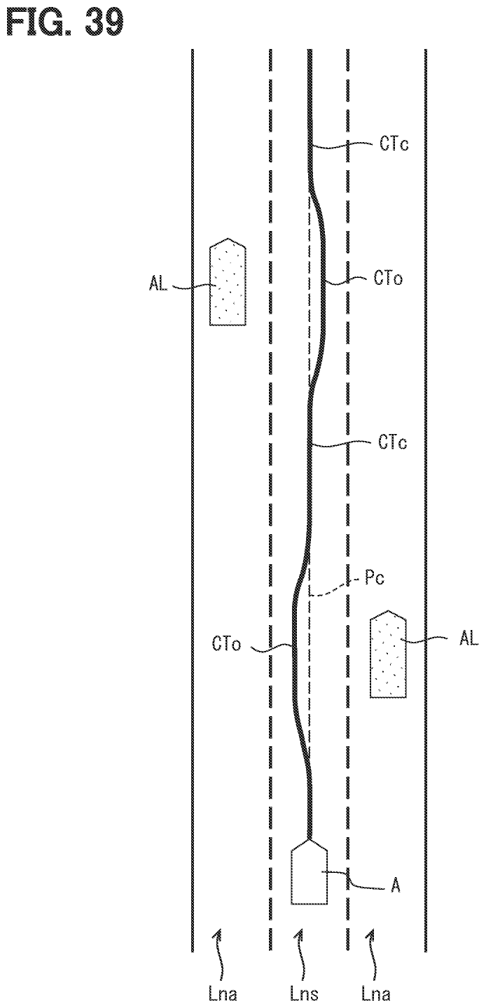

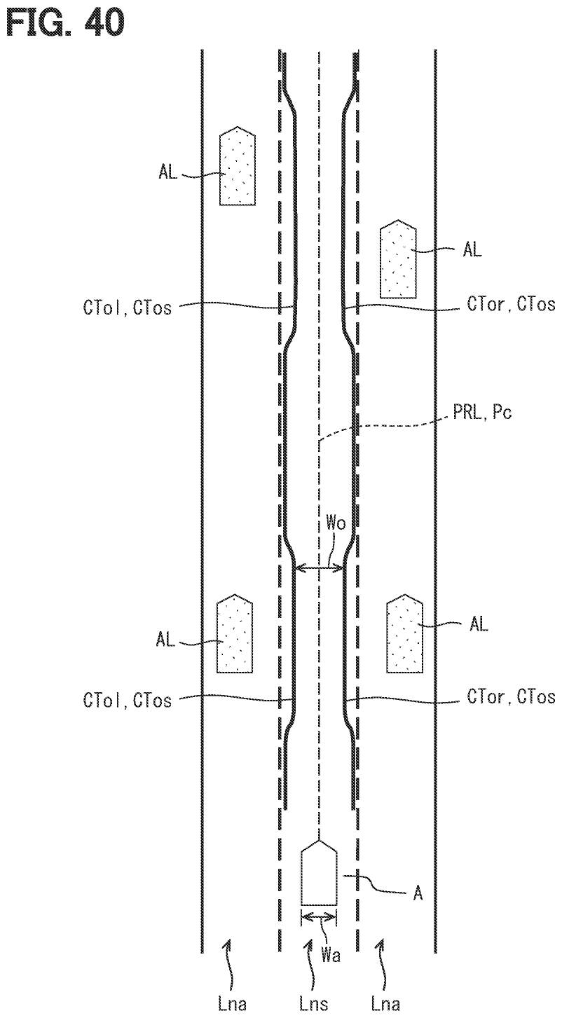

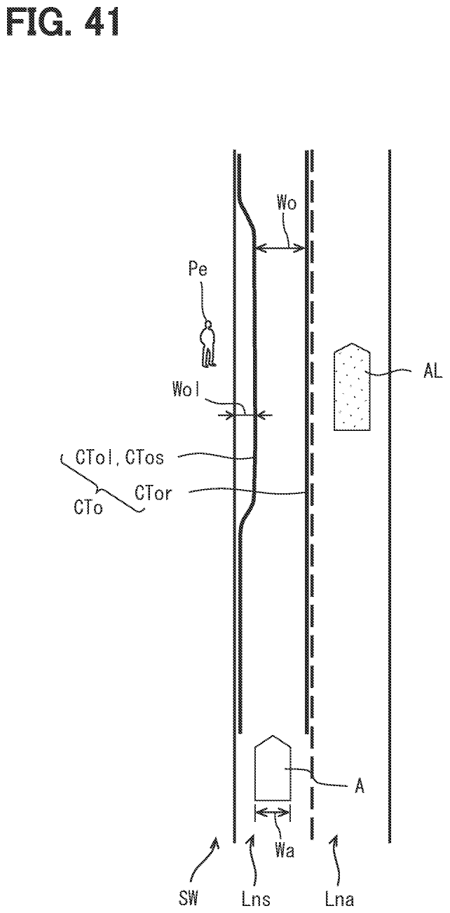

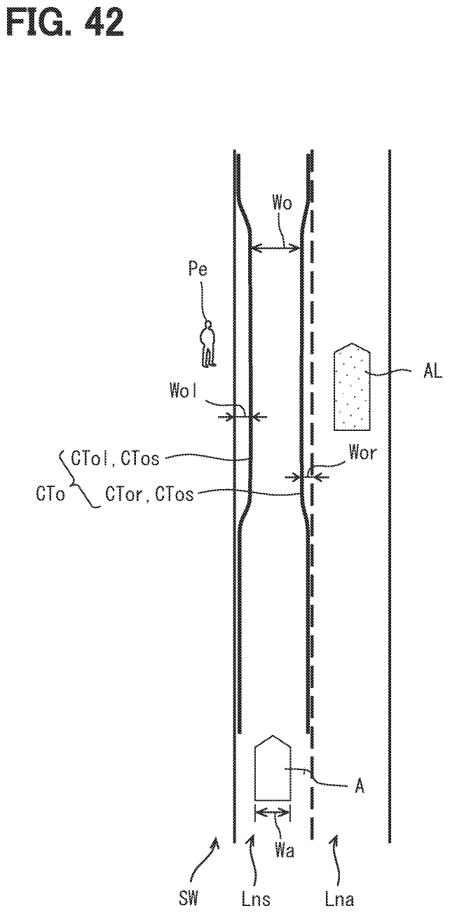

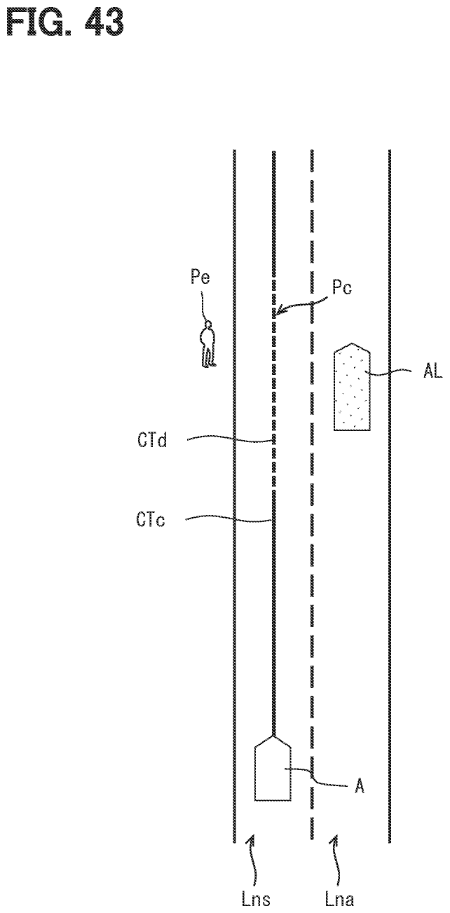

FIG. 29 is a flowchart illustrating in detail a display control process according to the sixth embodiment along with FIG. 11;

FIG. 30 is a diagram illustrating an offset display according to a first modification;

FIG. 31 is a diagram illustrating an offset display according to a second modification;

FIG. 32 is a diagram illustrating an offset start display under offset control assuming a pedestrian to be a control target according to a third modification;

FIG. 33 is a diagram illustrating a normal display according to the third modification;

FIG. 34 is a diagram illustrating an offset start display according to a fourth modification when the offset control is provided at a fork;

FIG. 35 is a diagram illustrating an offset start display according to the second embodiment in a travel scene where the offset control is provided at a fork;

FIG. 36 is a diagram illustrating an overview of offset content displayed according to a fifth modification;

FIG. 37 is a diagram illustrating an offset start display according to the fifth modification;

FIG. 38 is a diagram illustrating an offset stop display according to the fifth modification;

FIG. 39 is a diagram illustrating a display according to the first embodiment in a travel scene where the offset control is successively provided for control targets existing on the right and left of the subject vehicle;

FIG. 40 is a diagram illustrating a display according to the second embodiment in a travel scene where the offset control is provided for control targets existing on the right and left of the subject vehicle to move the subject vehicle to the center of a lane;

FIG. 41 is a diagram illustrating an overview of offset content displayed according to a sixth modification;

FIG. 42 is a diagram illustrating an overview of offset content displayed according to a seventh modification; and

FIG. 43 is a diagram illustrating a deceleration content displayed according to an eighth modification.

### DETAILED DESCRIPTION

Recently, there is a spreading use of lane keeping control that forces a vehicle to travel within a subject vehicle lane. It would be reasonable to consider the use of offset control as one function of the lane keeping control. Unlike the lane change control, the offset control does not move the vehicle to the adjacent lane but moves the traveling position of the vehicle from the center to the right or left in the subject vehicle lane. The offset control can easily ensure a distance from large vehicles or obstacles. However, if the offset control is automatically activated, the user of the vehicle may feel uncomfortable with the sidewise movement of the vehicle.

The present disclosure provides a display control device and a non-transitory computer-readable storage medium storing instructions, which are capable of reducing user's discomfort with the offset control and increasing the user convenience.

According to a first aspect of the present disclosure, a display control device is used for a vehicle and controls displays on a head-up display. The display control device includes an information acquisition unit and a display control unit. From a lane keeping control unit that controls the vehicle to travel within a subject vehicle lane, the information acquisition unit acquires offset information about an offset control to move a traveling position of the vehicle from a center unit of the subject vehicle lane to the right or left. Based on the offset information, the display control unit superimposedly displays an offset content indicating fulfillment of the offset control on a road surface in a foreground.

According to a second aspect of the present disclosure, a display control program is used for a vehicle and controls displays on a head-up display. The display control program allows one or more processors to perform a process as follows. From a lane keeping control unit that controls the vehicle to travel within a subject vehicle lane, the process acquires offset information about an offset control to move a traveling position of the vehicle from a center portion of the subject vehicle lane to the right or left. The process superimposedly displays an offset content indicating fulfillment of the offset control on a road surface in a foreground based on the offset information.

According to a third aspect of the present disclosure, a non-transitory computer-readable storage medium stores program instructions for controlling a head-up display of a vehicle. The program instructions cause one or more processors to acquire, from a lane keeping control unit that controls the vehicle to travel within a subject vehicle lane, offset information about an offset control to move a travelling position of the vehicle from a center portion of the subject vehicle lane to right or left, and to superimposedly display an offset content indicating fulfillment of the offset control on a road surface in a foreground based on the offset information. According to these aspects, the offset content notifies a vehicle user of the fulfillment of the offset control when the lane keeping control unit moves the traveling position of the vehicle from the center portion to the right or the left. By viewing the offset content, the user can recognize that the vehicle moves horizontally under the offset control. It is possible to reduce user's discomfort with offset control and increase user convenience.

Embodiments of the present disclosure will be described by reference to the accompanying drawings. The same reference numerals may be used for the mutually corresponding elements in the embodiments to omit a duplicate description. A subsequent embodiment may describe only part of the configuration. In such a case, the other part of the configuration applies to the corresponding part of the configuration described in the preceding embodiment. Combinations of the configurations are not limited to those explicitly described in the embodiments. The configurations of the embodiments may be partially combined, even if not explicitly described, except for an invalid combination. The description below shall disclose an implicit combination of the embodiments and the configurations described in the modifications.

### First Embodiment

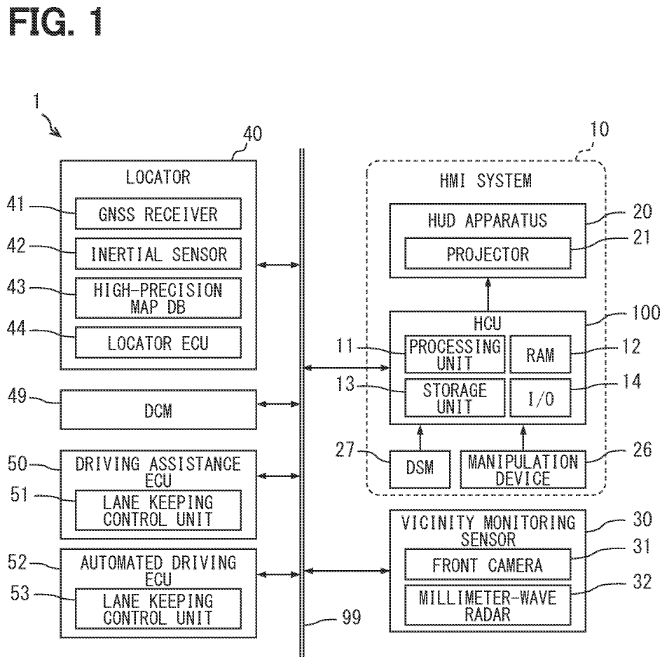

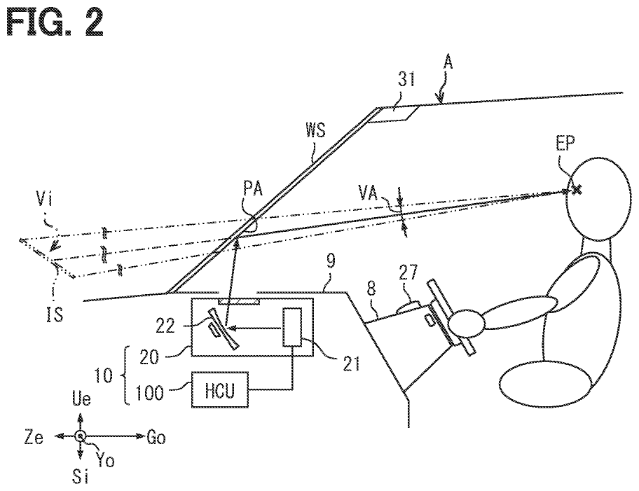

An HCU (Human Machine Interface Control Unit) 100 illustrated in FIGS. 1 and 2 provides functions of a display control device according to the first embodiment of the present disclosure. The HCU 100 configures an HMI (Human Machine Interface) system 10 used for vehicle A along with a head-up display (HUD) 20, for example. The HMI system 10 further includes an operation device 26 and a driver status monitor (DSM) 27, for example. The HMI system 10 includes an input interface function to accept user operations by an occupant (such as a driver) of vehicle A and an output interface function to provide the driver with information.

The HMI system 10 is communicably connected to a communication bus 99 of an onboard network 1 mounted on vehicle A. The communication bus 99 of the onboard network 1 connects with nodes such as a vicinity monitoring sensor 30, a locator 40, DCM 49, a driving assistance ECU (Electronic Control Unit) 50, and an automated driving ECU 52, for example. These nodes connected to communication bus 99 can communicate with each other. The specific nodes of these devices and ECUs may be directly electrically connected and may be capable of communication without the intermediation of the communication bus 99.

The following description defines a front-back direction (see Ze corresponding to forward and Go corresponding to backward in FIG. 2) and a horizontal direction (see Yo corresponding to sideways in FIG. 2) based on vehicle A motionlessly stationed on a level plane. Specifically, the front-back direction is defined in the longitudinal direction (traveling direction) of vehicle A. The horizontal direction is defined in the width direction of vehicle A. A vertical direction (see Ue corresponding to upward and Si corresponding to downward in FIG. 2) is defined as the vertical direction against the level plane that defines the front-back direction and the horizontal direction. The symbols representing the directions may be omitted as appropriate for simplification.

The vicinity monitoring sensor 30 is an autonomous sensor that monitors the surrounding environment of vehicle A. The vicinity monitoring sensor 30 can detect moving objects and stationary objects from a detection range around the subject vehicle. The moving objects include pedestrians, cyclists, non-human animals, and other vehicles, for example. The stationary objects include falling objects on the road, guardrails, curbs, road signs, road markings such as road lane lines, and structures beside the road, for example. The vicinity monitoring sensor 30 uses the communication bus 99 to provide, for example, the driving assistance ECU 50 and the automated driving ECU 52 with detection information about objects detected around vehicle A.

The vicinity monitoring sensor 30 includes a front camera 31 and a millimeter-wave radar 32 as detection configurations for object detection. The front camera 31 outputs at least one of the imaging data acquired by capturing the front range of vehicle A and an analysis result of the imaging data as detection information. The multiple millimeter-wave radars 32 are placed, for example, on the front and rear bumpers of vehicle A at intervals. The millimeter-wave radar 32 irradiates millimeter waves or quasi-millimeter waves around vehicle A in the range corresponding to the front, front-side, rear, and rear-side. The millimeter-wave radar 32 generates detection information based on a process of receiving waves reflecting off moving objects and stationary objects, for example. Incidentally, the vicinity monitoring sensor 30 may include the detection configurations such as LIDAR and a sonar.

The locator 40 generates, for example, highly accurate position information about vehicle A based on composite positioning that combines multiple pieces of acquired information. The locator 40 can identify a lane for vehicle A to travel among multiple lanes, for example. The locator 40 is configured to include a GNSS (Global Navigation Satellite System) receiver 41, an inertial sensor 42, a high-precision map database (high-precision map DB) 43, and a locator ECU 44.

The GNSS receiver 41 receives positioning signals transmitted from multiple artificial satellites (positioning satellites). The GNSS receiver 41 can receive positioning signals from positioning satellites of at least one of the satellite positioning systems such as GPS, GLONASS, Galileo, IRNSS, QZSS, and Beidou.

The inertial sensor 42 includes a gyro sensor and an acceleration sensor, for example. The high-precision map DB 43 is mainly composed of non-volatile memory and stores map data (high-precision map data) more accurate than that used for normal navigation. The high-precision map data maintains detailed information at least about the height (z) direction. The high-precision map data contains information available for advanced driving assistance and automated driving such as three-dimensional shape information about roads, information about the number of lanes, and information indicating travel directions allowed for the lanes.

The locator ECU 44 mainly includes a microcomputer equipped with a processor, RAM, a storage unit, an input/output interface, and a bus connecting these. The locator ECU 44 combines positioning signals received by the GNSS receiver 41, measurement results from the inertial sensor 42, and the vehicle speed information output to the communication bus 99 and successively measures subject vehicle positions and traveling directions of vehicle A, for example.

The locator ECU 44 uses the communication bus 99 to provide the HCU 100, driving assistance ECU 50 and the automated driving ECU 52, for example, with the position information and the direction information about vehicle A based on the positioning result.

The vehicle speed information represents the current traveling speed of vehicle A and is generated based on detection signals from a wheel speed sensor provided for the hub portion of each wheel of vehicle A. It is possible to change as needed the node (ECU) that generates the vehicle speed information and outputs it to the communication bus 99. For example, an onboard ECU such as a brake control ECU to control the distribution of braking force to each wheel or the HCU 100 is electrically connected to the wheel speed sensor for each wheel and continuously generates the vehicle speed information and outputs it to the communication bus 99.

The locator ECU 44 determines whether the high-precision map DB 43 contains the required high-precision map data in response to a request from the HCU 100, for example. If the high-precision map DB 43 contains the required high-precision map data, the locator ECU 44 reads the corresponding high-precision map data from the high-precision map DB 43 and supplies it to the requesting ECU.

The DCM (Data Communication Module) 49 provides a communication module mounted on vehicle A. The DCM 49 transmits and receives radio waves to and from base stations around vehicle A through the use of wireless communication compliant with communication standards such as LTE (Long Term Evolution) and 5G. The DCM 49, when mounted, enables vehicle A to be connected to the Internet. The DCM 49 can acquire the latest high-precision map data from a cloud-based probe server. The DCM 49 cooperates with the locator ECU 44 to update the high-precision map data stored in the high-precision map DB 43 to the latest information.

The driving assistance ECU 50 and the automated driving ECU 52 are each mainly composed of a computer equipped with a processor, RAM, a storage unit, an input/output interface, and a bus connecting these. The driving assistance ECU 50 has a driving assistance function to assist the driver's driving operations. The automated driving ECU 52 has an automated driving function capable of acting for the driver's driving operations. For example, the driving assistance ECU 50 enables partially automated driving control (advanced driving assistance) corresponding to level 2 or lower according to the automated driving levels specified by the Society of Automotive Engineers. Contrastingly, the automated driving ECU 52 enables automatic driving control corresponding to level 3 or higher.

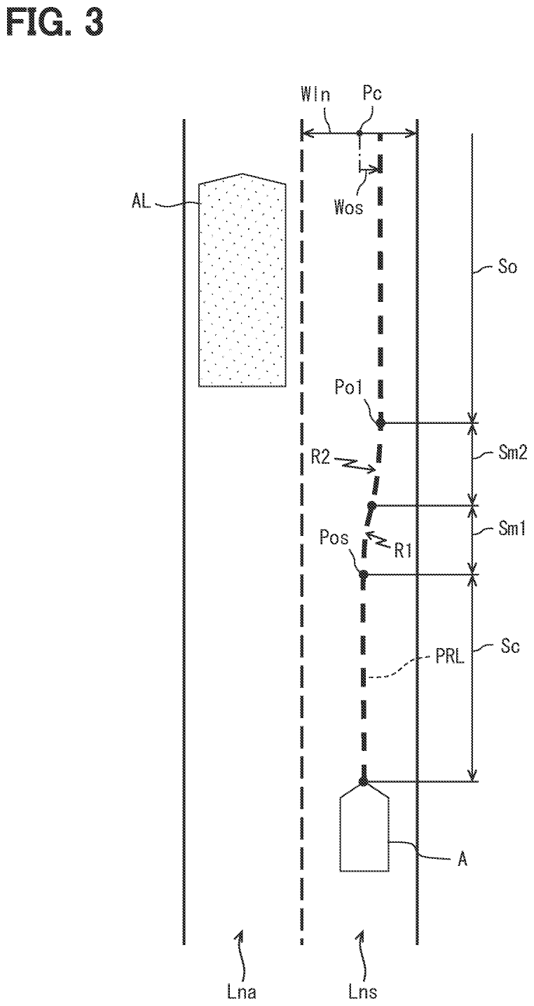

The driving assistance ECU 50 and the automated driving ECU 52 recognize the traveling environment around vehicle A based on the detection information acquired from the vicinity monitoring sensor 30. The ECUs 50 and 52 provide the HCU 100 with analyzed detection information, namely, the result of analyzing the detection information acquired for the recognition of the traveling environment. For example, the ECUs 50 and 52 can provide the HCU 100 with positions of the lane (see subject vehicle lane Lns in FIG. 3) currently traveled by vehicle A relative to the right and left lane lines or roadsides. As above, the right and left directions correspond to the width direction of vehicle A motionlessly stationed on a level plane based on the traveling direction of vehicle A.

The driving assistance ECU 50 allows the processor to execute programs stored in the storage unit and thereby provides multiple function units that embody advanced driving assistance. Specifically, the driving assistance ECU 50 includes an ACC control unit, an LTA control unit, and an LCA control unit 51. The ACC control unit provides a function unit that embodies ACC (Adaptive Cruise Control) functions. The ACC control unit causes vehicle A to constantly travel at a target vehicle speed, or causes vehicle A to follow a leading vehicle while maintaining an inter-vehicular distance from the leading vehicle.

The lane keeping control unit 51 is a function unit to implement the LTA (Lane Tracing Assist) function. LTA is also called LTC (Lane Trace Control). The lane keeping control unit 51 controls steering angles of a steering wheel of vehicle A based on the shape information about lane lines or roadway edges extracted from imaging data of the front camera 31. The lane keeping control unit 51 generates scheduled travel line PRL (see FIG. 3) to follow subject vehicle lane Lns (see FIG. 3) being traveled. The lane keeping control unit 51 cooperates with the ACC control unit and provides lane keeping control (or lane-following control) to force vehicle A to travel subject vehicle lane Lns according to scheduled travel line PRL.

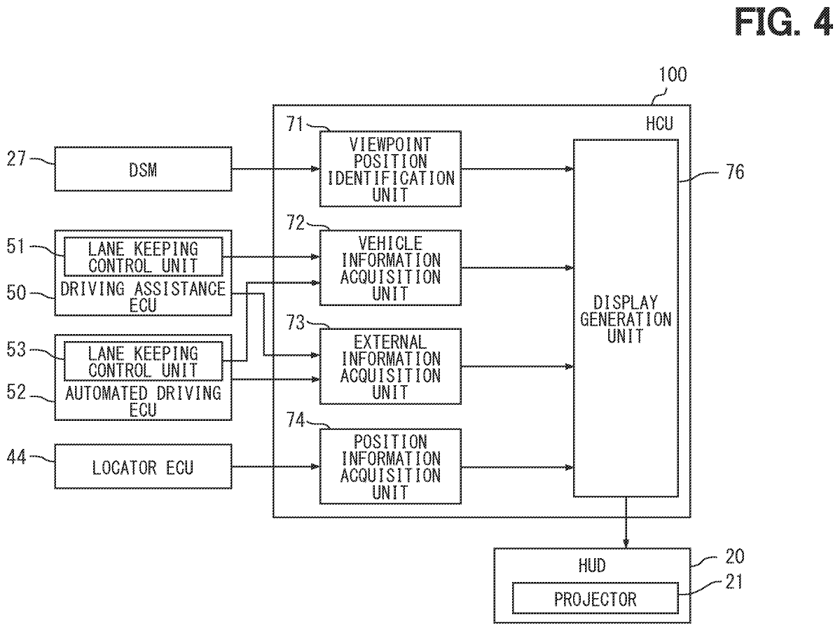

The automated driving ECU 52 allows the processor to execute programs stored in the storage unit and thereby provides multiple function units that embody autonomous travel of vehicle A. The automated driving ECU 52 generates scheduled travel line PRL (see FIG. 4) based on the high-precision map data and the subject vehicle position information acquired from the locator 40 as well as the detection information acquired from the proximity monitoring sensor 30. The automated driving ECU 52 provides acceleration and deceleration control and steering control, for example, so that vehicle A travels along scheduled travel line PRL.

The automated driving ECU 52 includes a function part that provides lane keeping control substantially the same as the lane keeping control unit 51 of the driving assistance ECU 50, namely, driving control that allows vehicle A to travel subject vehicle lane Lns. This function part is defined as a lane keeping control unit 53 for convenience. The user can exclusively use one of the lane keeping control units 51 and 53.

As illustrated in FIGS. 1 through 3, the lane keeping control units 51 and 53 can provide offset control as one of lane keeping control functions. The lane keeping control units 51 and 53 usually control traveling positions of vehicle A in subject vehicle lane Lns to approximately center portion Pc of subject vehicle lane Lns. The offset control moves traveling positions of vehicle A in subject vehicle lane Lns to the right or the left from center portion Pc of subject vehicle lane Lns.

The lane keeping control units 51 and 53 recognize the existence of control targets based on the detection information. The control targets include large vehicles AL traveling adjacent lane Lna (such as a climbing lane), vehicles parked at the road shoulder, pedestrians near the road shoulder, and falling objects on the road. The lane keeping control units 51 and 53 provide the offset control when these control targets exist.

Specifically, the lane keeping control units 51 and 53 generate scheduled travel line PRL shaped to depart from the control target. Scheduled travel line PRL specifies driving positions of vehicle A in subject vehicle lane Lns. The travel control based on scheduled travel line PRL provides the above-mentioned offset control. In principle, center portion Pc of subject vehicle lane Lns is the geometric center point in the width direction of subject vehicle lane Lns. As another control logic other than the above, the lane keeping control units 51 and 53 configure a control target region inappropriate to approach at least on the road surface of subject vehicle lane Lns depending on positions of the recognized control targets. The lane keeping control units 51 and 53 assume the configured control target region to be practically a restricted region and control the traveling positions in the horizontal direction so that vehicle A does not pass through the control target region.

When the lane keeping control is activated based on a user operation on the manipulation device 26, for example, the lane keeping control units 51 and 53 successively provide the HCU 100 with the lane keeping control information about the lane keeping control via the communication bus 99. The lane keeping control information includes at least status information indicating operating states of the lane keeping control and information (line shape information) indicating the shape of scheduled travel line PRL. The lane keeping control information may include information (region shape information) indicating the shape of the control target region in addition to or in place of the line shape information.

The status information indicates whether the lane keeping control function enters the off state, the standby state, or the execution state. The standby state indicates that the lane keeping control is activated but does not provide movement control. The lane keeping control enters the standby state when a provision condition is not satisfied such that no section line can be recognized, for example. The execution state indicates that the operation control is activated based on the satisfied execution condition. When the lane keeping control enters the execution state, the status information further includes schedule information indicating whether the offset control is scheduled.

The line shape information includes at least three-dimensional coordinates of multiple specific points to define scheduled travel line PRL and the length and the curvature radius of a virtual line connecting specific points. Specifically, when the offset control is provided, scheduled travel line PRL specifies at least center travel section Sc, horizontal movement sections Sm1 and Sm2, and offset travel section So.

Center travel section Sc ordinarily allows traveling positions of vehicle A to be controlled at center portion Pc of subject vehicle lane Lns. Horizontal movement sections Sm1 and Sm2 allow traveling positions of vehicle A to offset to the right or the left from center portion Pc in subject vehicle lane Lns. Horizontal movement sections Sm1 and Sm2 are assigned curvature radiuses R1 and R2 so that the horizontal acceleration or moving speed due to the horizontal movement does not exceed a predetermined upper limit value. In horizontal move section Sm1 as the first half, the horizontal acceleration is induced to depart from a control target such as large vehicle AL and vehicle A starts moving horizontally. In horizontal move section Sm2 as the second half, the acceleration is induced in the direction opposite to that of the first-half horizontal move section Sm1 and vehicle A completes the horizontal movement. Offset travel section So ensures the travel along subject vehicle lane Lns while keeping the travel position being offset from center portion Pc.

Furthermore, horizontal movement sections Sm3 and Sm4 are provided subsequent to offset travel section So. In horizontal movement section Sm3 as the first half, the acceleration is induced in the direction of allowing vehicle A to approach center portion Pc of subject vehicle lane Lns. In horizontal movement section Sm4 as the second half, the acceleration is induced in the direction opposite to that of the first-half horizontal movement section Sm3 and vehicle A completes the horizontal movement to return to center portion Pc.

In scheduled travel line PRL associated with the above-described offset control, the connection point between horizontal movement section Sm1 and center travel section Sc is defined as the position (offset start position Pos) to start the offset control. The connection point between horizontal movement section Sm2 and offset travel section So is defined as the position (offset completion position Po1) to complete the horizontal movement. When the offset control is canceled, the connection point between offset travel section So and the horizontal movement section (horizontal movement section Sm3 as the first half) is defined as the position (see offset cancellation start position Po2 in FIGS. 9 and 20) to start canceling the offset control. Similarly, the connection point between the horizontal movement section (horizontal movement section Sm4 as the second half) and center travel section Sc is defined as offset end position Poe (see FIGS. 9 and 20).

The line shape information contains information to define the shape of scheduled travel line PRL during the above-described offset control period. The information includes lane width Win of subject vehicle lane Lns and offset control amount Wos indicating the amount of horizontal variation in the traveling position based on center portion Pc. The line information output before the start of the offset control includes information indicating lengths and curvature radiuses of center travel section Sc and offset travel section So and three-dimensional coordinate information indicating positions of offset start position Pos and offset completion position Pot. The line shape information further contains information indicating curvature radiuses R1 and R2 of horizontal movement sections Sm1 and Sm2. The line information output before the cancellation of the offset control contains coordinate information indicating offset cancellation start position Po2 and offset end position Poe and information indicating curvature radiuses of horizontal movement sections Sm3 and Sm4 to return to center portion Pc.

Of the above-described lane keeping control information, the schedule information included in the status information and the line shape information to provide the offset control are comparable to offset information associated with the offset control. When the offset control is provided, the lane keeping information contains the offset information. When subject vehicle lane Lns is substantially linear, the curvature radiuses of center travel section Sc and offset travel section So are set to very large values. When subject vehicle lane Lns is curved, the curvature radiuses are set to values corresponding to the curved shape.

The description below explains in detail the operation device 26, the DSM 27, the HUD 20, and the HCU 100 included in the HMI system 10 based on FIGS. 1 and 2.

The operation device 26 is an input unit to accept operations by the user such as a driver. The manipulation device 26 is supplied with user operations to start and stop the driving assistance function and the automated driving function, for example. Specifically, the manipulation device 26 includes a steering switch provided for a spoke portion of the steering wheel, an operation lever provided for a steering column portion 8, and a voice input device to detect the driver's voice, for example.

The DSM 27 includes a near-infrared light source, a near-infrared camera, and a control unit (and the like) to control these. The DSM 27 is installed on the upper surface of the steering column portion 8 or the upper surface of the instrument panel 9, for example, so that the near-infrared camera faces the headrest portion of the driver's seat. The DSM 27 uses the near-infrared camera to capture the driver's head to which the near-infrared light is irradiated from the near-infrared light source. The control unit applies image analysis to images captured by the near-infrared camera. The control unit extracts information such as positions and eye directions of eyepoint EP from the captured image and successively outputs the extracted state information to the HCU 100.

The HUD 20 is mounted on vehicle A as one of the multiple onboard display devices along with a meter display and a central information display. The HUD 20 is electrically connected to the HCU 100 and successively acquires video data generated by the HCU 100. Based on the video data, the HUD 20 uses virtual image Vi to provide the driver with various information about vehicle A such as route information, sign information, and control information about the onboard functions.

The HUD 20 is housed in the accommodation space inside the instrument panel 9 below windshield WS. The HUD 20 projects the light formed as virtual image Vi toward projection range PA of windshield WS. The light projected on windshield WS is reflected toward the driver's seat in projection range PA and is perceived by the driver. The driver visually recognizes a display superimposed with virtual image Vi on the foreground visible through projection range PA.

The HUD 20 includes a projector 21 and an enlarging optical system 22. The projector 21 includes an LCD (Liquid Crystal Display) panel and a backlight. The projector 21 is fixed to the housing of the HUD 20 so that the display surface of the LCD panel faces the enlarging optical system 22. The projector 21 displays each frame image of the video data on the display surface of the LCD panel, applies transmitted illumination to the display surface using a backlight, and thereby emits the light formed as virtual image Vi toward the enlarging optical system 22. The enlarging optical system 22 includes at least one concave mirror formed by vapor depositing a metal such as aluminum on the surface of a base material made of synthetic resin or glass. The enlarging optical system 22 spreads the light emitted from the projector 21 by reflection and projects the light onto projection range PA positioned above.

The HUD 20 is given the angle of view VA. Suppose imaging plane IS corresponds to a virtual range in the space where virtual image Vi can be imaged on the HUD 20. Then, the angle of view VA represents a viewing angle defined based on a virtual line connecting the driver's eyepoint EP and the outer edge of imaging plane IS. The angle of view VA is comparable to an angle range that enables visual recognition of virtual image Vi viewed from eyepoint EP. The HUD 20 allows the horizontal angle of view (approximately 10 through 12 degrees, for example) in the horizontal direction to be larger than the vertical angle of view (approximately 4 through 5 degrees, for example) in the vertical direction. When viewed from eyepoint EP, a front range (a range of approximately a dozen to 100 meters, for example) overlapping projection range PA corresponds to the range within the angle of view VA.

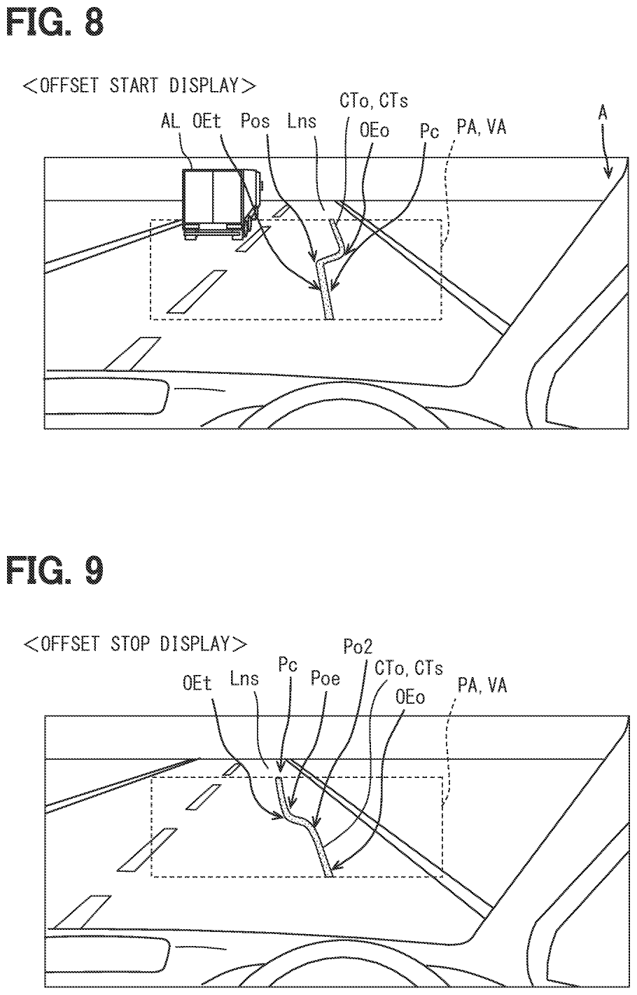

The HUD 20 displays superimposition content CTs (see FIG. 8, for example) and non-superimposition content CTn (see FIG. 7, for example) as virtual images Vi. Superimposition content CTs is an AR display object used for augmented reality (AR) display. Display positions of superimposition content CTs are associated with such specific superimposition targets as specific positions on a road surface, leading vehicles, pedestrians, and road signs existing in the foreground. Superimposition content CTs is superimposedly displayed on a specific superimposition target in the foreground and is seemingly secured relative to the superimposition target to be able to follow the superimposition target corresponding to the driver's eye line. Namely, the relative positional relationship is continuously maintained among the driver's eyepoint EP, the superimposition target in the foreground, and superimposition content CTs. Therefore, the shape of superimposition content CTs is continuously updated at a predetermined cycle according to the relative position and shape of the superimposition target. Superimposition content CTs is displayed to be approximately leveled compared to non-superimposition content CTn and provides a display shape extending in the depth direction (traveling direction or forward denoted as Ze) when viewed from the driver, for example.

The non-superimposition content CTn is a non-AR display object belonging to the display objects displayed in a superimposing manner on the foreground except superimposition content CTs. Unlike superimposition content CTs, non-superimposition content CTn is displayed in a superimposing manner on the foreground independently of specified superimposition targets. The display position of non-superimposition content CTn is not associated with a particular superimposition target. Non-superimposition content CTn is displayed at a predetermined position within projection range PA (the above-mentioned angle of view VA). Therefore, non-superimposition content CTn is displayed as if it is relatively fixed to a vehicle configuration such as windshield WS. In addition, non-superimposition content CTn substantially has a constant shape. Even non-superimposition content CTn may be displayed in a superimposing manner on a superimposition target of superimposition content CTs depending on the positional relationship between vehicle A and the superimposition target.

The HCU 100 is an electronic control apparatus that integratively controls displays of multiple onboard display devices including the HUD 20 in the HMI system 10. For example, the HCU 100 and the HUD 20 configure a virtual image display system.

The HCU 100 is mainly composed of a computer equipped with a processing unit 11, RAM 12, a storage unit 13, an input/output interface 14, and a bus connecting these. The processing unit 11 is the hardware combined with the RAM 12 for arithmetic processing. The processing unit 11 includes at least one arithmetic core such as a CPU (Central Processing Unit) or a GPU (Graphics Processing Unit). The processing unit 11 may further include an FPGA (Field-Programmable Gate Array), an NPU (Neural network Processing Unit), and other IP cores having dedicated functions, for example. The RAM 12 may include video RAM for video generation. The processing unit 11 accesses the RAM 12 to perform various processes to embody the functions of function units described later. The storage unit 13 includes a non-volatile storage medium. The storage unit 13 stores various programs (such as a display control program) executed by the processing unit 11.

The HCU 100 illustrated in FIGS. 1, 2 and 4 includes multiple function units that control the superimposing display of contents via the HUD 20 by allowing the processing unit 11 to execute the display control program stored in the storage unit 13. Specifically, the HCU 100 configures the function units such as a viewpoint position identification unit 71, a vehicle information acquisition unit 72, an external information acquisition unit 73, a position information acquisition unit 74, and a display generation unit 76.

The viewpoint position identification unit 71 identifies positions of eyepoint EP of the driver sitting in the driver's seat based on the state information acquired from the DSM 27. The viewpoint position identification unit 71 generates three-dimensional coordinates (eyepoint coordinates) indicating positions of eyepoint EP and successively supplies the generated eyepoint coordinates to the display generation unit 76.

The vehicle information acquisition unit 72 acquires at least the lane keeping control information the lane keeping control units 51 and 53 output to the communication bus 99. The vehicle information acquisition unit 72 successively provides the display generation unit 76 with the status information and line shape information included in the lane keeping control information. The lane keeping control units 51 and 53 can provide the lane keeping control information about a range wider than the range around vehicle A. The lane keeping control units 51 and 53 provide the vehicle information acquisition unit 72 with at least the lane keeping control information about a range (50 to 200 meters around vehicle A, for example) required for superimposing display of superimposition content CTs. The lane keeping control units 51 and 53 may provide the vehicle information acquisition unit 72 with the lane keeping control information virtually on a constant basis during the period of activating the vehicle maintenance control, for example, or on an as-needed basis when the offset control schedule is determined.

The external information acquisition unit 73 acquires detection information about the range around vehicle A, particularly about the front range, from at least one of the driving assistance ECU 50 and the automated driving ECU 52. Specifically, the external information acquisition unit 73 acquires detection information indicating relative positions of the right and left lane lines of subject vehicle lane Lns or roadway edges. The external information acquisition unit 73 successively provides the display generation unit 76 with the acquired detection information. The external information acquisition unit 73 may acquire imaging data of the front camera 31 as detection information instead of the detection information as analysis results acquired from the driving assistance ECU 50 or the automated driving ECU 52. The external information acquisition unit 73 may acquire detection information about objects as control targets for the offset control, such as large vehicle AL on adjacent lane Lna. The external information acquisition unit 73 may acquire all the detection information recognized by at least one of the driving assistance ECU 50 and the automated driving ECU 52 instead of the limited acquisition of detection information required for superimposing display of superimposition content CTs,

The position information acquisition unit 74 acquires, from the locator ECU 44, the latest position information and orientation information about vehicle A as the subject vehicle position information needed for the superimposing display of the superimposition content CTs. The position information acquisition unit 74 acquires the high-precision map data in the range around vehicle A from the locator ECU 44. The position information acquisition unit 74 successively provides the display generation unit 76 with the acquired subject vehicle position information and high-precision map data. The locator ECU 44 can provide information about a range wider than the range around vehicle A. The locator ECU 44 also provides the position information acquisition unit 74 with information about a range (50 to 200 meters around vehicle A, for example) needed for superimposing display of superimposition content CTs.

The display generation unit 76 generates video data successively output to the HUD 20 and thereby controls the HUD 20 to provide the driver with information. The display generation unit 76 draws an original image of each content displayed as virtual image Vi on individual frame images composing the video data. When drawing the original image of superimposition content CTs (see FIG. 8, for example) on the frame image, the display generation unit 76 corrects the drawing position and the drawing shape of the original image in the frame image depending on positions of eyepoint EP and the superimposition target. When viewed from eyepoint EP, superimposition content CTs is then displayed at the position and in the shape to be correctly superimposed on the superimposition target.

The display generation unit 76 further includes a virtual layout function and a content selection function to embody the above-mentioned video data generation function. The virtual layout function simulates the display layout of superimposition content CTs based on various information provided to the display generation unit 76. The display generation unit 76 acquires status information indicating that the lane keeping control unit 51 or 53 activates the lane keeping control. In this case, the display generation unit 76 reproduces the current driving environment of vehicle A in the virtual space based on the subject vehicle position information, the high-precision map data, and the detection information, for example. The display generation unit 76 may start simulating the display layout through the use of intrinsic determination based on the lane keeping control information.

To be more specific, as illustrated in FIGS. 2 through 5, the display generation unit 76 places subject vehicle object AO at a reference position in the virtual three-dimensional space. Based on the subject vehicle position information, the display generation unit 76 maps a road model, shaped according to the high-precision map data, to the three-dimensional space in association with subject vehicle object AO. The display generation unit 76 sets scheduled travel trace PR, shaped according to the line shape information, on the road model. The display generation unit 76 sets virtual camera position CP and superimposition range SA in association with subject vehicle object AO.

The virtual camera position CP provides a virtual position corresponding to the driver's eyepoint EP. The display generation unit 76 successively corrects virtual camera position CP for subject vehicle object AO based on the latest eyepoint coordinates acquired by the viewpoint position identification unit 71. The superimposition range SA enables the superimposing display of virtual image Vi. The display generation unit 76 sets superimposition range SA based on virtual camera position CP and outer edge position (coordinate) information on the imaging plane IS previously stored in the storage unit 13 (see FIG. 1), for example. Superimposition range SA is comparable to a front range positioned inside projection range PA when viewed forward from virtual camera position CP. Superimposition range SA corresponds to the angle of view VA of the HUD 20.

The display generation unit 76 places belt-like virtual object VO to overlap scheduled travel line PRL placed on the road surface of a road model in the three-dimensional space. Virtual object VO is shaped to correspond to center content CTc (see FIG. 7) and offset content CTo (see FIG. 8) to be described later. Namely, the shape of virtual object VO viewed from virtual camera position CP corresponds to virtual image shapes of content CTc and CTo visually recognized from eyepoint EP. When the road model is curved in a scene of traveling a curve, for example, scheduled travel line PRL and virtual object VO are also curved according to the road model.

The content selection function selects contents used to present the information. When the lane keeping control function is activated, the display generation unit 76 selects contents to be drawn in the video data based on the display layout simulation result. Specifically, the display generation unit 76 references the positional relationship between offset start position Pos and superimposition range SA in the display layout simulation result and determines whether offset start position Pos is located within the angle of view VA. Based on these determination results, the display generation unit 76 differently uses superimposition content CTs and non-superimposition content CTn and provides the driver with the information associated with the lane keeping control.

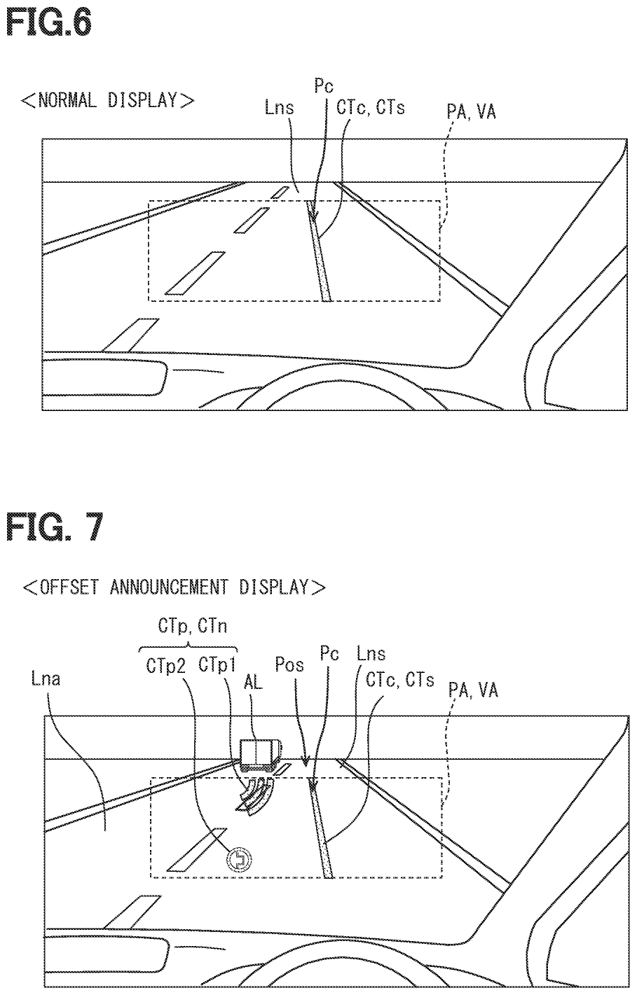

The display generation unit 76 can draw center content CTc (see FIGS. 6 and 7), announcement content CTp (see FIG. 7), and offset content CTo (see FIGS. 8 and 9) as the contents associated with the lane keeping control.

Center content CTc is used for the normal display (see FIG. 6) when no offset control is scheduled. Center content CTc is also used for the offset announcement display (see FIG. 7) when offset start position Pos is located outside the angle of view VA. Center content CTc indicates that the lane keeping control remains in the execution state and that the lane keeping control units 51 and 53 control traveling positions of vehicle A to center portion Pc of subject vehicle lane Lns. The normal display is also initially displayed immediately after the lane keeping control enters the execution state.

Center content CTc is a superimposition content CTs that is superimposedly displayed on the road surface of subject vehicle lane Lns in the foreground. Center content CTc assumes center portion Pc of subject vehicle lane Lns to be a superimposition target. The drawing shape is determined based on virtual object VO placed by the display layout simulation. Center content CTc extends in the shape of a narrow belt from the subject vehicle in the traveling direction so as to follow center portion Pc on the road surface of subject vehicle lane Lns. Center content CTc is drawn in a shape to reflect scheduled travel line PRL and indicates an estimated trace of vehicle A traveling under the lane keeping control. When subject vehicle lane Lns is linear, center content CTc is linear. When subject vehicle lane Lns is curved, center content CTc is curved along the curve. While vehicle A travels, the drawing shape of center content CTc is updated at a predetermined update cycle so as to correspond to the road surface shape viewed from eyepoint EP.

Announcement content CTp is used for the offset announcement display (see FIG. 7) when the offset control is scheduled and offset start position Pos is located outside the angle of view VA. Announcement content CTp is a non-superimposition content CTn and informs the driver about the provision of offset control, for example. Announcement content CTp is represented in a ripple-like or icon-like mode and is displayed as a virtual image sideways toward center content CTc.

In the foreground, ripple-shaped announcement content CTp (ripple-like content CTp1) emphasizes the existence of a control target (such as large vehicle AL) as a factor to provide the offset control. Ripple-like content CTp1 is displayed toward the control target based on center content CTc. Ripple-like content CTp1 has a display shape that centers approximately on the upper edge of projection range PA and spreads toward the center of projection range PA.

Iconic announcement content CTp (announcement icon CTp2) is a display object containing an arrow-shaped image portion and an outer image portion. The arrow-shaped image portion is shaped in a crank whose center protrudes in the offset direction. The outer image portion circularly surrounds the arrow-shaped image portion. Announcement icon CTp2 is displayed toward the control target and near the lower edge of projection range PA based on center content CTc.

Ripple-like content CTp1 and announcement icon CTp2 are displayed intermittently, for example, until offset start position Pos enters the angle of view VA. As another example, ripple-like content CTp1 may be continuously displayed during a period from the offset start display to the offset stop display. Ripple-like content CTp1 and announcement icon CTp2 may use substantially the same display color and display brightness as those of center content CTc or offset content CTo. Alternatively, ripple-like content CTp1 and announcement icon CTp2 may use display colors more noticeable than the color of center content CTc. Ripple-like content CTp1 and announcement icon CTp2 may use the display brightness higher than that of center content CTc.

Offset content CTo is displayed continuously during the period from the offset start display (see FIG. 8) to the offset stop display (see FIG. 9), indicating the provision of offset control. In the offset start display, offset content CTo indicates that offset control is about to take place. In the offset stop display, offset content CTo indicates the end of offset control.

Similar to center content CTc, offset content CTo is a superimposition content CTs that is superimposedly displayed on the road surface of subject vehicle lane Lns in the foreground. Offset content CTo is displayed continuously along with center content CTc. More specifically, as offset start position Pos enters the angle of view VA, the display generation unit 76 continuously transitions the display from center content CTc to offset content CTo. Similarly, as offset end position Poe exits the angle of view VA, the display generation unit 76 continuously transitions the display from offset content CTo to center content CTc.

Similar to center content CTc, the display layout simulation determines a drawing shape of offset content CTo based on virtual object VO placed on scheduled travel line PRL. The superimposition target for offset content CTo corresponds to a future traveling position based on scheduled travel line PRL on the road surface of subject vehicle lane Lns. Offset content CTo is drawn in a shape reflecting scheduled travel line PRL. Shaped like a narrow belt, offset content CTo extends from the subject vehicle in the traveling direction to represent an estimated trace of vehicle A that moves horizontally under the offset control.

Offset content CTo allows the drawing shape to be updated at a predetermined update cycle according to the travel of vehicle A to conform to the road surface shape viewed from eyepoint EP. However, scheduled travel line PRL to define the drawing shape of offset content CTo continuously uses information acquired at a specific timing, not the latest information successively acquired by the vehicle information acquisition unit 72. The estimated trace represented by offset content CTo is secured to the content generated at a specific timing. The display generation unit 76 reduces misalignment occurring on offset content CTo through the use of a process that interrupts the update of scheduled travel line PRL where virtual object VO is overlapped. The specific timing includes pre-starting timing before the time to start the horizontal movement of vehicle A or deviation timing to largely change the content of the latest scheduled travel line PRL from the content in use.

Offset content CTo may be displayed in a display color and display brightness different from or substantially equal to those of center content CTc. As an example, the display brightness of offset content CTo may be higher than that of center content CTc. As another example, the bandwidth of offset content CTo may be wider than that of center content CTc. The display generation unit 76 continuously changes differences between offset content CTo and center content CTc. Offset content CTo may be displayed intermittently while center content CTc may be displayed steadily.

In the offset start display (see FIG. 8), the display generation unit 76 may start displaying offset content CTo when offset start position Pos enters the angle of view VA. In the offset stop display (see FIG. 9), the display generation unit 76 may also start displaying offset content CTo when offset end position Poe or offset cancellation start position Po2 enters the angle of view VA.

In the offset start display, the display generation unit 76 may also start displaying offset content CTo indicating the offset control trace when a control target (such as large vehicle AL) enters the angle of view VA. In addition, the display generation unit 76 may display ripple-like content CTp1 while offset content CTo is displayed.

Offset content CTo may have the display shape of not only a solid line, but also a broken line, a chain line, a dotted line, and a set of intermittent dots (consecutive-dot sequences), for example. Compared to the solid line as the display shape, the broken line, the chain line, the dotted line, or the consecutive-dot sequence reduces a display area of offset content CTo in the angle of view VA. Therefore, it is possible to reduce visual obtrusiveness to the driver.

When the solid line represents an estimated trace under the lane keeping control, the solid line may also represent subtle misalignment of the control in the horizontal direction even if center portion Pc of subject vehicle lane Lns is shown. When the scheduled trace is shown with the solid line, the solid-line distortion faithfully representing the control may give the driver an uncomfortable feeling. Contrastingly, the use of the broken line, chain line, dotted line, or consecutive-dot sequence as the display shape to represent a scheduled trace can avoid noticeable representation of the distortion in the content due to misalignment of the lane keeping control. It is possible to reduce the occasions of giving the driver an uncomfortable feeling.

The description below particularizes some of the technical aspects concerning the first embodiment described so far.

<Technical Aspect 1>

As illustrated in FIG. 8, offset content CTo in the offset start display shows offset start position Pos and the control amount in the horizontal direction (offset control amount Wos) under the offset control.

As illustrated in FIG. 9, offset content CTo in the offset stop display shows offset cancellation start position Po2 and the control amount in the horizontal direction (offset control amount Wos).

Offset cancellation start position Po2 provides the position to start the offset control (offset cancellation control) that returns to the normal lane keeping control after overtaking a control target (such as large vehicle AL).

<Technical Aspect 1-1>

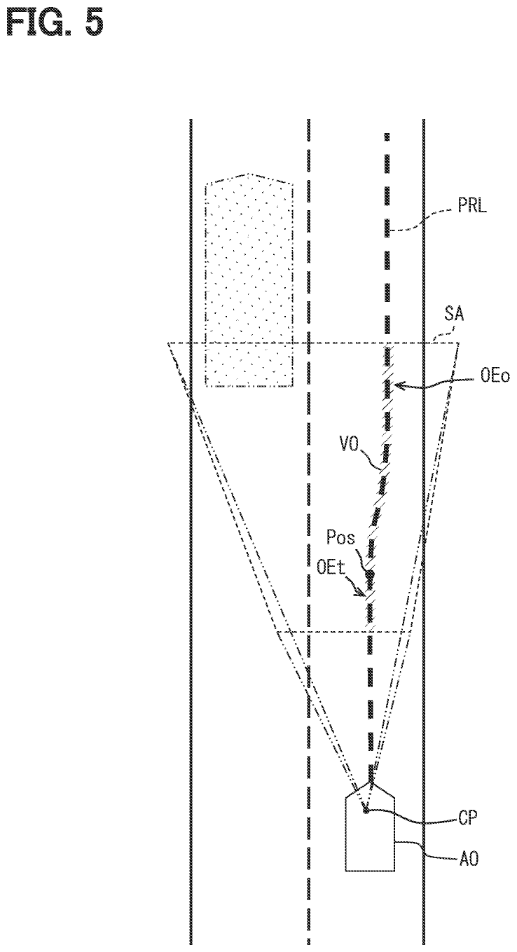

As illustrated in FIG. 5, virtual object VO to draw offset content CTo includes outer edge OEt near the control target and outer edge OEo distant from the control target.

In virtual object VO indicating the offset start, outer edge OEo distant from the control target spreads, stretches, or separates in the direction opposite to the control target or the lane line near the control target corresponding to the travel from offset start position Pos in the traveling direction. In other words, suppose virtual object VO is practically placed on the road surface in the foreground. Then, the corresponding outer edge OEo spreads, stretches, or separates in the direction to depart from the actual control target or the lane line near the control target corresponding to advance in the traveling direction.

When viewed from the driver, offset content CTo indicating the offset start is displayed as illustrated in FIG. 8. Specifically, outer edge OEo of offset content CTo opposite to the control target is viewed to seemingly spread, stretch, or separate in the direction opposite to the control target or the lane line near the control target corresponding to the travel from offset start position Pos in the traveling direction.

Virtual object VO indicating the offset end also includes outer edge OEt near the control target and outer edge OEo distant from the control target.

In virtual object VO indicating the offset end, outer edge OEt near the control target approaches, extends, or spreads toward the control target or the lane line near the control target corresponding to the travel from offset start position Pos in the traveling direction. In other words, suppose virtual object VO is practically placed on the road surface in the foreground. Then, the corresponding outer edge OEt approaches, extends, or spreads toward the actual control target or the lane line near the control target corresponding to advance in the traveling direction.

When viewed from the driver, offset content CTo indicating the offset end is displayed as illustrated in FIG. 9. Specifically, outer edge OEt of offset content CTo near the control target is viewed to seemingly approach, extend, or spread in the direction toward the control target or the lane line near the control target corresponding to the travel from offset start position Pos in the traveling direction.

<Technical Aspect 1-2: Notes on Technical Aspect 1-1>

In terms of offset content CTo indicating the offset start, outer edge OEo opposite to the control target spreads, extends, or separates in the direction opposite to the control target or the lane line near the control target corresponding to the travel from offset start position Pos in the traveling direction. After such a transition section is provided for a predetermined distance or longer in the traveling direction, outer edge OEo of offset content CTo is displayed to seemingly keep a substantially constant distance from the control target or the lane line near the control target.

In terms of offset content CTo indicating the offset end, outer edge OEt near the control target approaches, extends, or spreads toward the control target or the lane line near the control target corresponding to the travel from offset start position Pos in the traveling direction. After such a transition section is provided for a predetermined distance or longer in the traveling direction, outer edge OEt of offset content CTo is displayed to seemingly keep a substantially constant distance from the control target or the lane line near the control target.

<Technical Aspect 1-3>

Offset content CTo indicating the offset start ranges from offset start position Pos to the position (offset completion position Po1) to complete the offset control over the horizontal movement in the direction opposite to the control target.

Offset content CTo indicating the offset end ranges from offset cancellation start position Po2 to the position (offset end position Poe) to complete the offset control over the horizontal movement to the control target.

Offset content CTo indicating the offset end ranges from the position to start the offset control to a position of transition to the normal lane position control. In this case, the offset control overtakes another vehicle as the control target and then returns to the normal lane keeping control.

<Technical Aspect 1-4>

Offset content CTo indicating the offset start includes contents that are displayed at horizontally shifted positions as follows. One content is displayed at the superimposing position under the normal lane keeping control. The other content indicates the position to complete the offset control in the direction opposite to the control target.

Offset content CTo indicating the offset end includes contents that are displayed at horizontally shifted positions as follows. One content is superimposed on the road surface for offset cancellation start position Po2. The other content is superimposed on the position to complete the offset control that returns to the control target.

<Technical Aspect 1-5>

Offset content CTo indicating the offset start includes first, second, and third contents. The first content is placed toward the subject vehicle, namely, behind the start position (offset start point) to start the offset control. The second content is displayed in the traveling direction far away from the completion position (offset completion position Po1) to complete the offset control in the direction opposite to the control target. The third content is formed between the first and second contents.

Offset content CTo indicating the offset end includes fourth, fifth, and sixth contents. The fourth content is placed toward the subject vehicle, namely, behind the endpoint (offset cancellation start position Po2) of the offset control. The fifth content is displayed in the traveling direction far away from the completion position (offset end position Poe) to complete the horizontal movement to the control target to cancel the offset control. The sixth content is formed between the fourth and fifth contents.

Only the fourth and sixth contents may be displayed as offset content CTo indicating the offset end. Namely, the fifth content indicating the travel at the center of the lane is not displayed after vehicle A returns to center portion Pc of subject vehicle lane Lns and the offset control is complete. It is possible to prevent the driver from suffering inconvenience from superimposing display of the fifth content that simply shows the continued travel at center portion Pc during the period of the normal lane keeping control.

Furthermore, the fourth to sixth contents may be displayed as offset content CTo indicating the offset end and the fifth content may be continuously displayed for a predetermined time (such as 10 seconds). The continuously displayed fifth content can easily notify the driver that the normal lane keeping function continues after the offset control is canceled. The driver is less likely to experience inconvenience because the fifth content disappears after the predetermined time.

The description below explains in detail the display control method based on a display control program to switch between displays associated with the lane keeping control based on flowcharts illustrated in FIGS. 10 and 11 by reference to FIG. 3 and FIGS. 6 through 9. When the vehicle power is turned on, the HCU 100 completes a start-up process, for example, and then starts a display control process illustrated in FIGS. 10 and 11.

At S101, the lane keeping control unit 51 or 53 determines whether the lane keeping control is active based on the lane keeping control status information acquired by the vehicle information acquisition unit 72. It may be determined at S101 that the lane keeping control is inactive. Then, the process repeats the determination at S101 and maintains the standby state. The process does not provide at least a virtual image display associated with the lane keeping control. Suppose the lane keeping control unit 51 or 53 activates the lane keeping control. Then, the process proceeds to S102.

At S102, the process determines whether the lane keeping control satisfies the provision condition. It may be determined at S102 that the provision condition is not satisfied. Then, the process repeats the determination at S102 to maintain the standby state. It may be determined at S102 that the provision condition is satisfied. Then, the process proceeds to S103. Concurrently with the determination at S103, the lane keeping control unit 51 or 53 allows the lane keeping control to transition from the startup state to the execution state.

The lane keeping control units 51 and 53 use different provision conditions for the lane keeping control. Specifically, the provision condition for the lane keeping control in the lane keeping control unit 51 is that two lane lines (or roadway edges) to partition subject vehicle lane Lns are recognizable. The provision condition for the lane keeping control in the lane keeping control unit 53 is that the two lane lines (or roadway edges) are recognizable and high-precision map data is available.

At S103, the process starts the normal display (see FIG. 6) indicating the execution state of the lane keeping control, and proceeds to S104. Based on S103, the process superimposedly displays belt-like center content CTc on center portion Pc of the road surface of subject vehicle lane Lns.

At S104, the process acquires the latest lane keeping control information from the lane keeping control unit 51 or 53 in the execution state and proceeds to S105. At S105, the process references the schedule information contained in the lane keeping control information acquired at S104 and determines whether the offset control is scheduled. It may be determined at S105 that the offset control is not scheduled. Then, the process proceeds to S106.

At S106, the process references the status information in the lane keeping control information acquired at S104 and determines whether the lane keeping control transitions to the off state or the startup state. It may be determined that at S106 that the lane keeping control does not enter the execution state. Then, the display control process associated with the lane keeping control once terminates. Control returns to S101. It may be determined at S106 that the lane keeping control maintains the execution state. Then, control returns to S103. In this case, the process continues the normal display (see FIG. 6) based on the latest lane keeping control information. As a result, center content CTc notifies the driver, for example, that the traveling position of vehicle A is controlled to center portion Pc of subject vehicle lane Lns.

It may be determined at S105 that the offset control is scheduled. Then, the process proceeds to S107, references the display layout simulation result, and determines whether offset start position Pos is located within the angle of view VA. It may be determined at S107 that offset start position Pos is located outside the angle of view VA. Then, the process proceeds to S108. At S108, the process starts the offset announcement display (see FIG. 7) including announcement content CTp in addition to center content CTc. The offset announcement display continues until offset start position Pos enters the angle of view VA.

It may be determined at S107 that offset start position Pos is located within the angle of view VA due to continued travel of vehicle A. Then, the process proceeds to S109. At S109, the process transitions center content CTc to offset content CTo according to the transformation in the offset direction, forms the offset start display (see FIG. 8), and proceeds to S110. At S110, similar to S104, the process acquires the latest lane keeping control information and proceeds to S111.

At S111, the process references the display layout simulation result and determines whether offset end position Poe is located within the angle of view VA. It may be determined at S111 that offset end position Poe is located outside the angle of view VA. Then, the process proceeds to S112. At S111, the process may determine whether offset cancellation start position Po2, instead of offset end position Poe, is located within the angle of view VA.

At S112, the process compares the line shape information acquired at S110 with the line shape information used to define drawing shapes of offset content CTo and determines whether scheduled travel line PRL is significantly changed. The amount of deviation generated on scheduled travel line PRL may exceed a threshold value as a result of comparing the line shape information at S112. Then, the process proceeds to S113. At S113, the process updates the shape of offset content CTo to a shape reflecting the latest scheduled travel line PRL and returns to S110.

At S112, it may be determined that the amount of deviation generated on scheduled travel line PRL is smaller than or equal to the threshold value and scheduled travel line PRL is not significantly changed. Then, the process returns to S110. Consequently, the process continues to draw offset content CTo based on scheduled travel line PRL (virtual object VO in FIG. 4) so far.

It may be determined at S111 that offset end position Poe is located within the angle of view VA. Then, the process proceeds to S114. At S114, the process starts the offset stop display (see FIG. 9) that bends offset content CTo toward the center. At S114, the process causes the display transition from offset content CTo to center content CTc and then returns to S103. Consequently, the offset stop display changes to the normal display (see FIG. 6).

According to the first embodiment described so far, the lane keeping control units 51 and 53 may move the traveling position of vehicle A from center portion Pc to the right or the left. In this case, offset content CTo notifies the user such as a driver that the offset control is provided. The user can view offset content CTo and recognize that vehicle A moves horizontally under the offset control. Consequently, it is possible to reduce the user's discomfort in the offset control and improve the user's convenience.

According to the first embodiment, offset content CTo indicates an estimated trace for vehicle A scheduled to travel under the offset control through the use of the drawing based on scheduled travel line PRL generated by the lane keeping control units 51 and 53. Such a display mode of offset content CTo can allow the user to recognize the provision of offset control in a more comprehensible manner.

According to the first embodiment, the estimated trace provided by offset content CTo is secured to a content generated at a specific timing. Offset content CTo is hardly misaligned even if the lane keeping control units 51 and 53 repeatedly update scheduled travel line PRL. Therefore, it is possible to avoid a situation where offset content CTo to notify the offset control adversely increases the user's inconvenience.

According to the first embodiment, the lane keeping control unit 51 may control the traveling position of vehicle A to center portion Pc of subject vehicle lane Lns. In this case, center content CTc indicating the provision of the center keeping control is superimposedly displayed on the road surface of subject vehicle lane Lns. The user may view offset content CTo different from center content CTc and thereby can easily understand that the offset control different from the center keeping control is provided.

The first embodiment continuously provides the display transition from center content CTc to offset content CTo and the display transition from offset content CTo to center content CTc. Changes in the display allow the user to easily understand the transition from the center keeping control to the offset control and the transition from the offset control to the center keeping control.

The first embodiment displays announcement content CTp informing the provision of offset control when offset start position Pos in the foreground is located outside the angle of view VA of the HUD 20. Therefore, the user can be preliminarily notified of the scheduled offset control despite limitations on the angle of view VA of the HUD 20.

Offset content CTo according to the first embodiment is superimposed, in a belt-like shape, on the future traveling position on the road surface. Offset content CTo extending in the belt-like shape can noticeably indicate the future traveling position of vehicle A. The user can easily anticipate the future behavior of vehicle A by visually recognizing offset content CTo.

According to the first embodiment, offset content CTo notifies the user of the end of offset control. As a result, offset content CTo can continuously represent a series of offset control from the beginning to the end in detail corresponding to the travel of vehicle A. The user can easily understand the future behavior of vehicle A and therefore feel more comfortable with the lane keeping control.

In the first embodiment, offset start position Pos is comparable to a “start position (of offset control).” The vehicle information acquisition unit 72 is comparable to an “information acquisition unit.” The display generation unit 76 is comparable to a “display control unit.” The HCU 100 is comparable to a “display control device.”

### Second Embodiment

FIGS. 12 through 20 illustrate the second embodiment of the present disclosure as a modification of the first embodiment. The second embodiment differs from the first embodiment in the mode of displays associated with the lane keeping control. Specifically, center content CTc and offset content CTo are superimposition contents CTs that include right boundary lines CTcr and CTor and left boundary lines CTcl and CTol, respectively. The description below explains in detail the displays of patterns according to the second embodiment in turn.

Similar to the first embodiment, the normal display (initial display) illustrated in FIG. 12 is displayed when the lane keeping control remains in the execution state and no offset control is scheduled (see S103 in FIG. 10). The normal display contains center content CTc. Center content CTc displays right boundary line CTcr and left boundary line CTcl extending along subject vehicle lane Lns and thereby shows that the lane keeping control units 51 and 53 (see FIG. 4) control traveling positions of vehicle A within subject vehicle lane Lns.

Right boundary line CTcr specifies a superimposition target near the right lane line on the road surface of subject vehicle lane Lns. The drawing shape of right boundary line CTcr is determined based on right virtual object VOr (see FIG. 19) placed during the display layout simulation. Right boundary line CTcr is located inside the right lane line and, in the shape of a narrow belt, extends from the subject vehicle in the traveling direction along the right lane line.

Left boundary line CTcl specifies a superimposition target near the left lane line on the road surface of subject vehicle lane Lns. The drawing shape of left boundary line CTcl is determined based on left virtual object VOI (see FIG. 19) placed during the display layout simulation. Left boundary line CTcl extends in the shape of a narrow belt from the subject vehicle in the traveling direction along the left lane line.

Right boundary line CTcr and left boundary line CTcl are placed to sandwich center portion Pc of subject vehicle lane Lns on the right and left sides, and are displayed at positions to be substantially equally spaced from center portion Pc. Therefore, as described above, center content CTc shows that the traveling position of vehicle A is controlled to center portion Pc of subject vehicle lane Lns.

Right boundary line CTcr and left boundary line CTcl have drawing shapes that reflect scheduled travel line PRL (see FIG. 19). Therefore, right boundary line CTcr and left boundary line CTcl can cooperatively indicate an estimated trace of vehicle A traveling under the lane keeping control. In addition, right boundary line CTcr and left boundary line CTcl have a function of indicating the range (travelable range) recognized as travelable by the lane keeping control units 51 and 53 (see FIG. 4).

Similar to the first embodiment, the offset announcement display illustrated in FIG. 13 is provided when offset start position Pos for the offset control scheduled by the lane keeping control units 51 and 53 (see FIG. 4) is located outside the angle of view VA (see S108 in FIG. 11). The offset announcement display contains announcement content CTp in addition to center content CTc.

Announcement content CTp is a superimposition content CTs that forms a display combined with center content CTc. Announcement content CTp is a display object that is continuous with specific boundary line CTcs, namely, right boundary line CTcr or left boundary line CTcl whichever is close to the control target (such as large vehicle AL) for the offset control. Announcement content CTp is superimposedly displayed along with specific boundary line CTcs on the road surface of subject vehicle lane Lns.

Specifically, announcement content CTp is drawn in the shape of a broken line that branches from specific boundary line CTcs. Announcement content CTp includes a branching image portion and an extending image portion. The branching image portion branches from the middle of specific boundary line CTcs toward center portion Pc. The extending image portion extends from the inner tip of the branching image section in the traveling direction along specific boundary line CTcs.

Announcement content CTp is continuously displayed in an approximately constant shape until offset start position Pos enters the angle of view VA. The display color of announcement content CTp is substantially the same as that of center content CTc. The display brightness of announcement content CTp may be substantially the same as that of center content CTc or may be higher than that of center content CTc to emphasize the offset control schedule. Announcement content CTp may blink.

As illustrated in FIG. 14, offset start position Pos enters the angle of view VA to initiate a transition display from the offset announcement display (see FIG. 13) to the offset start display (see FIG. 15) (see S109 in FIG. 11). This transition display shows an animation that bends the traveling direction side (upper side) of specific boundary line CTcs (left boundary line CTcl) toward center portion Pc of subject vehicle lane Lns. Specific boundary line CTcs transforms from a straight line to a crank shape and concurrently allows the tip portion pointing in the traveling direction to approach announcement content CTp. As a result, specific boundary line CTcs allows the tip portion to be superimposed on the whole of announcement content CTp. Thus, the offset start display is formed. Another available bending animation transforms superimposition content CTs in response to the entry to the angle of view VA on condition that superimposition content CTs is generated before the entry to the angle of view VA.

The offset start display illustrated in FIGS. 15 and 16 contains offset content CTo. Similar to center content CTc (see FIG. 12), offset content CTo contains right boundary line CTor and left boundary line CTol and is displayed concurrently with center content CTc. The drawing shape of right boundary line CTor is determined based on right virtual object VOr (see FIG. 19) placed during the display layout simulation. Similarly, the drawing shape of left boundary line CTol is determined based on left virtual object VOI (see FIG. 19) placed during the display layout simulation.

During the display layout simulation, the display generation unit 76 (see FIG. 4) allows virtual object VOr or VOI, whichever defines specific boundary line CTos, to be curved along scheduled travel line PRL (see FIG. 17). Therefore, specific boundary line CTos has a drawing shape that is bent or curved in the direction separating from the control target. The offset width of right virtual object VOr toward the center corresponds to offset control amount Wos (see FIG. 3) defined for scheduled travel line PRL and is substantially equal to a conversion value used to apply offset control amount Wos to the virtual space. However, the offset width of right virtual object VOr may be greater than the conversion value for offset control amount Wos in the virtual space.

Offset content CTo can show an estimated trace of vehicle A horizontally moving under the offset control mainly through the use of the bent or curved shape of specific boundary line CTos. Moreover, offset content CTo can show not only a decrease in the travelable range recognized by the lane keeping control but also an occurrence of the forthcoming offset control based on a decrease in the horizontal distance between right boundary line CTor and left boundary line CTol.

The drawing shape of offset content CTo is updated at a predetermined update cycle corresponding to the travel of vehicle A to conform to the road surface shape viewed from eyepoint EP (see FIG. 2). The second embodiment also continuously uses the information acquired at a specific timing for scheduled travel line PRL (see FIG. 19) that defines the shapes of virtual objects VOr and VOI. The scheduled trace and the travelable range represented by offset content CTo are secured to the contents generated at a specific timing.

Similar to the first embodiment, the offset stop display illustrated in FIGS. 17 and 18 is provided when offset end position Poe (or offset cancellation start position Po2) for the offset control enters the angle of view VA (see S114 in FIG. 11). In the offset stop display, specific boundary line CTos (left boundary line CTol) of offset content CTo is bent in the direction separating from center portion Pc of subject vehicle lane Lns at offset cancellation start position Po2. Specific boundary line CTos is shaped so that the tip portion pointing in the traveling direction approaches the section line and extends in the traveling direction along the lane line. Offset content CTo can show not only an increase in the travelable range recognized by the lane keeping control units 51 and 53 (see FIG. 4) but also the end of the offset control based on an increase (restoration) in the horizontal distance between boundary lines CTor and CTol.

The description below particularizes technical aspects concerning the offset start display and the offset stop display according to the second embodiment described so far. Technical aspects 2s through 2s-6 below concern the offset start display. Technical aspects 2e through 2e-6 concern the offset stop display.

<Technical Aspect 2s>

As illustrated in FIG. 19, virtual object VOI indicating the offset start curves along scheduled travel line PRL. The curve starts from offset start position Pos. Therefore, virtual object VOI indicating the offset start shows offset start position Pos and offset control amount Wos in the horizontal direction. In the offset start display illustrated in FIG. 16, offset content CTo (specific boundary line CTos) drawn from virtual object VOI shows offset start position Pos and offset control amount Wos in the horizontal direction.

<Technical Aspect 2s-1>

As illustrated in FIG. 19, virtual object VOI indicating the offset start includes outer edge OEt toward the control target and outer edge OEo opposite to the control target. In virtual object VOI indicating the offset start, outer edge OEo opposite to the control target expands, extends, or separates from the control target or the lane line near the control target in the opposite direction corresponding to the travel from offset start position Pos in the traveling direction. In other words, suppose virtual object VOI is practically placed on the road surface in the foreground. Then, the corresponding outer edge OEo spreads, extends, or separates in the direction to depart from the actual control target or the lane line near the control target corresponding to advance in the traveling direction.

When viewed from the driver, offset content CTo (left boundary line CTol as specific boundary line CTos) indicating the offset start is displayed as illustrated in FIGS. 15 and 16. Specifically, outer edge OEo of specific boundary line CTos opposite to the control target is visually recognized as expanding, extending, or separating from the control target or the lane line near the control target in the opposite direction corresponding to the travel from offset start position Pos in the traveling direction.

<Technical Aspect 2s-2: Notes on Technical Aspect 2s-1>

In terms of offset content CTo (specific boundary line CTos) indicating the offset start, outer edge OEt opposite to the control target spreads, extends, or separates in the direction opposite to the control target or the lane line near the control target corresponding to the travel from offset start position Pos in the traveling direction. After such a transition section is provided for a predetermined distance or longer in the traveling direction, outer edge OEt of offset content CTo is displayed to keep a constant distance from the control target or the lane line near the control target.

<Technical Aspect 2s-3>

Offset content CTo (specific boundary line CTos) indicating the offset start ranges from offset start position Pos to the position (offset completion position Po1) to complete the offset control over the horizontal movement in the direction opposite to the control target.

<Technical Aspect 2s-4>

As illustrated in FIG. 19, advance in the traveling direction decreases the horizontal distance between right virtual object VOr and left virtual object VOI. As illustrated in FIG. 16, offset content CTo generated based on virtual objects VOr and VOI is also superimposed on the road surface so that the horizontal distance between boundary lines CTor and CTol decreases corresponding to advance in the traveling direction (above or Ue in appearance). As above, offset content CTo can show not only a decrease in the travelable range recognized by the lane keeping control but also an occurrence of the forthcoming offset control.

<Technical Aspect 2s-5>

Offset content CTo (specific boundary line CTos) indicating the offset start contains two contents. Specific boundary line CTos allows the two contents to be displayed at horizontally displaced positions. One content is displayed at the superposition position under the normal lane keeping control. The other content indicates the position to complete the offset control in the direction opposite to the control target.

<Technical Aspect 2s-6>

Offset content CTo (specific boundary line CTos) indicating the offset start includes seventh, eighth, and ninth contents. The seventh content is placed at a position (nearer to the subject vehicle) behind the position (offset start point) to start the offset control. The eighth content is displayed in the traveling direction away from the position (offset completion position Po1) to complete the offset control in the direction opposite to the control target. The ninth content is formed between the seventh content and the eighth content.

<Technical Aspect 2e>

As illustrated in FIG. 20, virtual object VOI indicating the offset end curves along scheduled travel line PRL. The curve starts from offset cancellation start position Po2. Therefore, virtual object VOI indicating the offset cancellation start shows offset cancellation start position Po2 and offset control amount Wos in the horizontal direction. In the offset stop display illustrated in FIG. 18, offset content CTo (specific boundary line CTos) drawn from virtual object VOI shows offset cancellation start position Po2 and offset control amount Wos in the horizontal direction. Offset cancellation start position Po2 is also used to start the offset control (offset cancellation control) that returns to the normal lane keeping control after overtaking the control target.

<Technical Aspect 2e-1>

As illustrated in FIG. 20, virtual object VOI indicating the offset end includes outer edge OEt near the control target and outer edge OEo opposite to the control target. In virtual object VOI indicating the offset start, outer edge OEo opposite to the control target expands, extends, or separates toward the control target or the lane line near the control target corresponding to the travel from offset cancellation start position Po2 in the traveling direction.

When viewed from the driver, offset content CTo (left boundary line CTol) indicating the offset end is displayed as illustrated in FIGS. 17 and 18. Specifically, outer edge OEo of offset content CTo (specific boundary line CTos) opposite to the control target is visually recognized as expanding, extending, or separating from the control target or the lane line near the control target corresponding to the travel from offset cancellation start position Po2 in the traveling direction.

<Technical Aspect 2e-2: Notes on Technical Aspect 2e-1>

In terms of offset content CTo (specific boundary line CTos) indicating the offset end, outer edge OEt opposite to the control target expands, extends, or separates toward the control target or the lane line near the control target corresponding to the travel from offset cancellation start position Po2 in the traveling direction. After such a transition section is provided for a predetermined distance or longer in the traveling direction, outer edge OEt of offset content CTo is displayed to keep a constant distance from the control target or the lane line near the control target.

<Technical Aspect 2e-3>

Offset content CTo (specific boundary line CTos) indicating the offset end ranges from offset cancellation start position Po2 to the position (offset end position Poe) to complete the offset control over the horizontal movement to the control target.

Offset content CTo indicating the offset end ranges from the position to start the offset control to a position of transition to the normal lane keeping control. In this case, the offset control overtakes another vehicle as the control target and then returns to the normal lane keeping control.

<Technical Aspect 2e-4>

As illustrated in FIG. 19, advance in the traveling direction decreases the horizontal distance between right virtual object VOr and left virtual object VOI. As illustrated in FIG. 20, after the control to overtake another vehicle, advance in the traveling direction increases the horizontal distance between right virtual object VOr and left virtual object VOI.

As illustrated in FIG. 18, offset content CTo generated based on virtual objects VOr and VOI is also superimposed on the road surface so that the horizontal distance between boundary lines CTor and CTol increases corresponding to advance in the traveling direction (above or Ue in appearance). As above, offset content CTo can show not only an increase in the travelable range recognized by the lane keeping control but also an occurrence of the forthcoming offset control that returns to the normal lane keeping control.

<Technical Aspect 2e-5>

Offset content CTo (specific boundary line CTos) indicating the offset end contains two contents. Specific boundary line CTos allows the two contents to be displayed at horizontally displaced positions. One content is superimposed on the road surface for offset cancellation start position Po2. The other content is superimposed on the position to complete the offset control that returns to the control target.

<Technical Aspect 2e-6>

Offset content CTo (specific boundary line CTos) indicating the offset end includes tenth, eleventh, and twelfth contents. The tenth content is placed at a position (nearer to the subject vehicle) behind the position (offset cancellation start position Po2) to end the offset control. The eleventh content is displayed in the traveling direction far away from the completion position (offset end position Poe) to complete the horizontal movement to the control target to cancel the offset control. The twelfth content is formed between the tenth content and the eleventh content.

Only the tenth and twelfth contents may be displayed as offset content CTo indicating the offset end. This eliminates the display of the eleventh content showing that vehicle A returns to center portion Pc of subject vehicle lane Lns and travels at the center of the lane after completion of the offset control. It is possible to prevent the driver from suffering inconvenience from superimposing display of the eleventh content that simply shows the continued travel at center portion Pc during the period of the normal lane keeping control.

Furthermore, the tenth to twelfth contents may be displayed as offset content CTo indicating the offset end and the eleventh content may be continuously displayed for a predetermined time (such as 10 seconds). The continuously displayed eleventh content can easily notify the driver that the normal lane keeping function continues after the offset control is canceled. The driver is less likely to experience inconvenience because the eleventh content disappears after the predetermined time.

The second embodiment described so far also provides the same effect as that of the first embodiment. Offset content CTo notifies the provision of the offset control. It is possible to reduce the user's discomfort in the offset control.

Offset content CTo according to the second embodiment shows the provision of the offset control by using the display that decreases the distance between right border line CTor and left border line CTol. Offset content CTo also provides a function that enables right boundary line CTor and left boundary line CTol to indicate not only the scheduled trace of vehicle A but also the travelable range recognized by the system. The user can feel more comfortable because of the noticeably represented detection result as the basis of the lane keeping control.

Offset content CTo may deviate from the superimposition target depending on the vehicle behavior and road surface conditions. However, the display to decrease the distance between right boundary line CTor and left boundary line CTol hardly causes a situation where the entire contents are located on the lane line. Therefore, offset content CTo can maintain the mode that is easily recognized by the driver. However, right boundary line CTor and left boundary line CTol may be defined as superimposition content CTs using the lane line as a superimposition target and may be superimposed on the lane line.

### Third Embodiment

FIG. 21 illustrates the third embodiment of the present disclosure as a modification of the second embodiment. The third embodiment and the second embodiment use substantially the same normal display (see FIG. 12) during the period when the lane keeping control units 51 and 53 (see FIG. 4) provide the center keeping control. The third embodiment differs from the second embodiment in the mode of offset displays during the period when the lane keeping control units 51 and 53 provide the offset control.

Offset content CTo for offset display according to the third embodiment includes left boundary line CTol and right boundary line CTor. Left boundary line CTol or right boundary line CTor nearer to the control target (large vehicle AL) is assumed to be specific boundary line CTos. Specific boundary line CTos is highlighted in the shape of a belt wider than boundary lines CTcr and CTcl (see FIG. 12) of center content CTc. There is substantially no change in the superimposing position of specific boundary line CTos, or more precisely, the position of outer edge OEt of the specific boundary line CTos near the control target. Specific boundary line CTos is shaped in a wide belt by extending outer edge OEo distant from the control target toward center portion Pc. Left boundary line CTol or right boundary line CTor not assumed to be specific boundary line CTos keeps the mode and is continuously displayed superimposedly on the road surface of subject vehicle lane Lns.

As a display to announce the offset control, for example, the display generation unit 76 (see FIG. 4) starts displaying an animation that widens specific boundary line CTos at the timing (see S108 in FIG. 11) before offset start position Pos enters the angle of view VA. The display generation unit 76 starts blinking specific boundary line CTos shaped in a wide belt at the timing (see S109 in FIG. 11) when offset start position Pos enters the angle of view VA. That is, the offset announcement display corresponds to the animated display that widens specific boundary line CTos toward center portion Pc. The offset start display corresponds to the animated display that blinks the widened specific boundary line CTos.

Suppose, for example, there is an offset start display for the offset control that moves to the right to depart from the control target on the left. Then, left boundary line CTol is comparable to specific boundary line CTos. In this case, offset content CTo includes left boundary line CTol and right boundary line CTor. Left boundary line CTol near the control target is horizontally transformed to be a content wider than right boundary line CTor opposite to the control target. In terms of offset content CTo indicating the offset start, the driver can visually recognize specific boundary line CTos as the content thicker than the lane line. Consequently, it is possible to reduce the risk that the driver misidentifies specific boundary line CTos as the lane line in the foreground.

The display generation unit 76 stops blinking specific boundary line CTos at the timing when offset cancellation start position Po2 (see FIG. 20) or offset end position Poe (see FIG. 20) enters the angle of view VA (see S114 in FIG. 11). The display generation unit 76 displays an animation that returns specific boundary line CTos to the original thickness. The animated display provides an offset stop display.

It is possible to accordingly change the details of the “animation to return to the original thickness” in the offset stop display. Specifically, the “animation to return to the original thickness” may be provided as follows. Specific boundary line CTos is displayed to be seemingly thinner corresponding to advance in the traveling direction. Specific boundary line CTos may be displayed in the angle of view VA corresponding to the travel of vehicle A, giving an animation effect of moving offset content CTo.

Specific boundary line CTos need not blink while the offset control is provided. The display generation unit 76 may thicken specific boundary line CTos at the timing when offset start position Pos enters the angle of view VA. Alternatively, the display generation unit 76 may thicken specific boundary line CTos at the timing when the control target enters the angle of view VA. The display generation unit 76 may display an animation that returns specific boundary line CTos to the original thickness at the timing when offset cancellation start position Po2 (see FIG. 20) or offset end position Poe (see FIG. 20) exits from the angle of view VA.

The third embodiment described so far provides the same effect as that of the second embodiment. Offset content CTo can represent the provision of the offset control by changing the thickness of specific boundary line CTos. It is possible to reduce the user's discomfort in the offset control.

### Fourth Embodiment

The fourth embodiment of the present disclosure illustrated in FIGS. 22 to 24 is another modification of the second embodiment. The fourth embodiment and the second embodiment use substantially the same normal display (see FIG. 12) during the period when the lane keeping control units 51 and 53 (see FIG. 4) provide the center keeping control. The fourth embodiment differs from the second embodiment in the mode of offset displays during the period when the lane keeping control units 51 and 53 provide the offset control. The description below explains in detail the displays of patterns according to the fourth embodiment in turn.

The offset announcement display illustrated in FIG. 22 is provided at the timing when offset start position Pos exits from the angle of view VA (see S108 in FIG. 11). In the offset announcement display, boundary line CTcr or CTcl (see FIG. 12), displayed as center content CTc near the control target (large vehicle AL), changes to announcement content CTp.

Announcement content CTp is shaped in an arrow that is bent in the middle of the whole shape toward the center of the lane. Announcement content CTp includes an outer extension portion, a bent extension portion, and a center extension portion. The outer extension portion extends in the traveling direction along the lane line near the edge of subject vehicle lane Lns. The bent extension portion extends from the tip of the outer extension portion toward center portion Pc. The center extension portion further extends from the inner end of the bent extension portion in the traveling direction. The tip of the center extension portion is formed with a point part pointing the traveling direction of vehicle A. Announcement content CTp is displayed as a wipe-like animation that repeatedly flows from the subject vehicle in the traveling direction.

The offset start display illustrated in FIG. 23 is provided when offset start position Pos enters the angle of view VA (see S109 in FIG. 11). The transition from the offset announcement display to the offset start display changes the remaining one of boundary lines CTcr and CTcl and announcement content CTp included in offset announcement display (see FIG. 22) to right boundary line CTor and left boundary line CTol. Right boundary line CTor and left boundary line CTol are each drawn in the shape of a narrow belt and are bent away from the control target (large vehicle AL) at offset start position Pos. Left boundary line CTol, one of boundary lines CTor and CTol, is close to the control target and allows the tip portion pointing in the traveling direction to be located closer to center portion Pc of subject vehicle lane Lns due to the bend or the curve at the middle similar to specific boundary line CTos according to the second embodiment. Right boundary line CTor, the boundary line distant from the control target, allows the middle part to be bent or curved to cross the lane line and allows the tip portion pointing in the traveling direction to be superimposed on the outside of subject vehicle lane Lns.

Offset content CTo uses bent or curved shapes of boundary lines CTor and CTol to show an estimated trace of vehicle A that moves horizontally under the offset control. As a result, the driver can preliminarily recognize the horizontal movement of vehicle A started at offset start position Pos. The horizontal distance between right boundary line CTor and left boundary line CTol is maintained. Offset content CTo hardly gives the user an impression of the reduced travelable range.

The offset stop display illustrated in FIG. 24 is provided when offset end position Poe enters the angle of view VA (see S114 in FIG. 11). Right boundary line CTor and left boundary line CTol are bent or curved in the direction in which vehicle A moves horizontally at offset end position Poe. The tips of boundary lines CTor and CTol are superimposed on both edges of subject vehicle lane Lns. Offset content CTo shows the transition from the offset control to the center keeping control through the use of the bent or curved shapes of boundary lines CTor and CTol.

The fourth embodiment described so far provides the same effect as that of the second embodiment. Offset content CTo can represent the provision of the offset control by changing the shapes of boundary lines CTor and CTol. It is possible to reduce the user's discomfort in the offset control.

### Fifth Embodiment

The fifth embodiment of the present disclosure illustrated in FIGS. 25 and 26 is still another modification of the second embodiment. The fifth embodiment and the second embodiment use substantially the same normal display (see FIG. 12) during the period when the center keeping control is active. The fifth embodiment differs from the second embodiment in the mode of displays during the period when the offset control is active. The description below explains in detail the displays of patterns according to the fifth embodiment in turn.

An offset announcement display illustrated in FIG. 25 allows announcement icon CTp2 to be displayed as announcement content CTp between boundary lines CTcr and CTcl displayed as center content CTc. Announcement icon CTp2 has substantially the same shape as that of the first embodiment. Announcement icon CTp2 is displayed as non-superimposition content CTn approximately at the center of projection range PA. Announcement icon CTp2 is displayed and located to be approximately equidistant from boundary lines CTcr and CTcl.

An offset start display illustrated in FIG. 26 changes announcement icon CTp2 and boundary lines CTcr and CTcl (see FIG. 25) to offset notification icon CToi and boundary lines CTor and CTol. Offset notification icon CToi is displayed in a display shape, display color, and display brightness that are substantially the same as those of announcement icon CTp2. Similarly, boundary lines CTor and CTol are also displayed in a display shape, display color, and display brightness that are substantially the same as those of boundary lines CTcr and CTcl.

Unlike announcement icon CTp2, offset notification icon CToi is superimposition content CTs. Offset notification icon CToi includes a superimposing position associated with offset start position Pos. When offset start position Pos enters the angle of view VA, offset notification icon CToi moves to specific boundary line CTos from the center of projection range PA to approach the control target (large vehicle AL). Offset notification icon CToi is continuously displayed near specific boundary line CTos while the offset control takes effect. When offset end position Poe (see FIG. 17) enters the angle of view VA, offset notification icon CToi moves to the center of projection range PA from the vicinity of specific boundary line CTos. Offset notification icon CToi functions as offset content CTo that preliminarily announces the schedule of starting and stopping the offset control through the use of the animation that horizontally moves relative to boundary lines CTor and CTol.

The fifth embodiment described so far also provides the same effect as that of the second embodiment. Offset notification icon CToi functions as offset content CTo that preliminarily announces the schedule of starting and stopping the offset control through the use of the animation that moves horizontally. It is possible to notify the provision of the offset control and reduce the user's discomfort in the offset control.

### Sixth Embodiment

The sixth embodiment of the present disclosure illustrated in FIGS. 27 through 29 is a modification of the third embodiment. To reduce the driver's discomfort, the sixth embodiment does not always display center content CTc in the normal display (see FIG. 27) during the period when the center keeping control is active. The display generation unit 76 repeatedly displays and hides center content CTc at a predetermined cycle as a normal display indicating the execution state of the lane keeping control. For example, the display generation unit 76 displays an animation that extends left and right boundary lines CTcr and CTcl away from the side of the subject vehicle in the traveling direction once every predetermined time (such as 5 seconds).

When the lane keeping control (center keeping control) starts, the display generation unit 76 displays an animation that flows boundary lines CTcr and CTcl in the traveling direction. When the schedule to provide the offset control is determined (S604: YES in FIG. 29), the display generation unit 76 also displays the animation that flows boundary lines CTcr and CTcl in the traveling direction (S605 in FIG. 29). Such an animation display effectively generates a sense of distance ahead. On completion of the offset control that returns the traveling position of vehicle A to center portion Pc, the display generation unit 76 terminates the offset stop display and then displays the animation that flows boundary lines CTcr and CTcl in the traveling direction. Such an animation display notifies the driver of the transition from the offset control to the normal control in an easy-to-understand manner.

When offset start position Pos enters the angle of view VA (S107: YES in FIG. 11), the display generation unit 76 starts displaying offset content CTo including right and left boundary lines CTor and CTol. The display generation unit 76 displays an animation that widens specific boundary line CTos located near the control target (large vehicle AL) (see FIG. 28). Specific boundary line CTos maintains the position of outer edge OEt near the control target, extends outer edge OEo distant from the control target toward center portion Pc, and is shaped in a thick belt. The display generation unit 76 determines the displacement of outer edge OEo according to offset control amount Wos (see FIG. 19) and thickens specific boundary line CTos as much as offset control amount Wos. In other words, the amount of widening specific boundary line CTos is determined based on the region shape information acquired by the vehicle information acquisition unit 72. As a result, from the driver's viewpoint, the road surface range to superimpose specific boundary line CTos corresponds to a control target region that inhibits the entry of vehicle A.

During the period of overtaking the control target, the display generation unit 76 continuously displays specific boundary line CTos that indicates the control target region to inhibit vehicle A from traveling. Similar to the normal display, it may be favorable to repeat, at a predetermined cycle, an animation display that extends specific boundary line CTos and the other boundary line (right boundary line CTor) forward during the period of overtaking the control target. After vehicle A overtakes the control target, the display generation unit 76 displays an animation, as an offset stop display, that restores the thickness of specific boundary line CTos (S114 in FIG. 11).

The fourth embodiment described so far also provides the same effect as that of the third embodiment. Offset content CTo can represent the provision of the offset control by changing the shape of specific boundary line CTos. It is possible to reduce the user's discomfort in the offset control. The animation display of widening specific boundary line CTos may be provided as an offset announcement display instead of an offset start display.

### OTHER EMBODIMENTS

While there have been described embodiments of the present disclosure, the disclosure should not be understood exclusively in terms of the above-mentioned embodiments but may be applicable to various embodiments and combinations within the spirit and scope of the disclosure.

As illustrated in FIG. 30, a first modification of the fifth embodiment differs from the fifth embodiment in contents of offset content CTo in the offset display. Offset content CTo according to the first modification does not contain the right and left borders. Offset content CTo according to the first modification contains a ripple-like content CTow in addition to offset notification icon CToi substantially the same as that of the fifth embodiment. Ripple-like content CTow is superimposition content CTs whose display position is associated with large vehicle AL, for example, as a factor to provide the offset control. Ripple-like content CTow is displayed near large vehicle AL not to overlap large vehicle AL and thereby emphasizes the existence of large vehicle AL.

Offset notification icon CToi according to the fifth embodiment and the first modification is superimposition content CTs and the superimposing position is associated with the offset start position. However, the offset notification icon may be a non-superimposition content whose display position is secured to the center of projection range PA (angle of view VA), for example. Similarly, the ripple-like content may be a non-superimposition content displayed at a specific position in projection range PA. Offset content CTo need not be a superimposition content if offset content CTo is superimposedly displayed on the road surface. Further, offset content CTo need not have a shape representing a scheduled trace of vehicle A.

According to a second modification of the third embodiment, illustrated in FIG. 31, boundary lines CTcr and CTcl (see FIG. 12) superimposed on the road surface of subject vehicle lane Lns change the display mode corresponding to the transition to the offset display. Specifically, specific boundary line CTos (left boundary line CTol) remains superimposed on the road surface of subject vehicle lane Lns and increases the belt width similarly to the third embodiment described above. The other boundary line (right boundary line CTor), not specific boundary line CTos, moves from the road surface of subject vehicle lane Lns to the outside of subject vehicle lane Lns.

The second modification may accordingly change the superimposing positions of the boundary lines included in the center content and offset content such as inside the lane line, positions overlapping the lane line, and outside the lane line, for example, within the angle of view VA. When the offset control is provided, the offset display may hide the boundary line distant from the control target such as large vehicle AL.

As above, control targets for the offset control are not limited to large vehicles traveling a climbing lane adjacent to the subject vehicle lane. As a third modification of the second embodiment illustrated in FIG. 32, the offset control may be provided for pedestrian Pe moving on sidewalk Sw adjacent to subject vehicle lane Lns. Even in such a travel scene, offset content CTo can notify the driver of the provision of offset control in the direction departing from pedestrian Pe through the use of specific boundary line CTos shaped to bend at offset start position Pos.

As illustrated in FIG. 33, guardrail GL is installed between subject vehicle lane Lns and sidewalk Sw. In this case, pedestrian Pe is extremely unlikely to go onto subject vehicle lane Lns. The lane keeping control portion, even if recognizing pedestrian Pe, continues the center keeping control without providing the offset control. No offset content is displayed when guardrail GL separates sidewalk Sw from subject vehicle lane Lns. In this case, the normal display continues by using center content CTc.

The offset control is also provided at highway forks, for example. In this case, the direction to move away from large vehicle AL under the offset control may correspond to the direction to move from subject vehicle lane Lns to branch lane Lnb. Then, the driver may wrongly assume that vehicle A has started moving towards branch lane Lnb.

The offset start display according to a fourth modification of the first embodiment illustrated in FIG. 34 provides barrier content CTb as well as offset content CTo indicating a scheduled trace of vehicle A. Barrier content CTb is displayed like a wall that is erected upward from the boundary area adjacent to branch lane Lnb on the road surface of subject vehicle lane Lns and prevents movement to branch lane Lnb. Barrier content CTb noticeably represents that there occurs no movement to branch lane Lnb.

As illustrated in FIG. 35, the offset start display according to the second embodiment allows two boundary lines CTor and CTol to be superimposedly displayed on the road surface of subject vehicle lane Lns. In this case, the boundary line (right boundary line CTor) near branch lane Lnb notifies the driver that there occurs no movement to branch lane Lnb.

To suppress misalignment of the offset content, the above-described embodiments perform the process (see S112 in FIG. 11) that secures the shape information about the scheduled travel line used for offset content drawing to the contents acquired at a specific timing. However, it may be favorable to accordingly update the shape information about the scheduled travel line by omitting the process to secure the scheduled travel line and the scheduled trace. It may be favorable to omit the display of the center content notifying the center keeping control and the display of the announcement content when the offset start position is located outside the angle of view.

A fifth modification of the second embodiment illustrated in FIGS. 36 through 38 differs from the second embodiment in superimposing positions of right boundary lines CTcr and CTor and left boundary lines CTcl and CTol displayed as center content CTc and offset content CTo. According to the fifth modification, right boundary lines CTcr and CTor and left boundary lines CTcl and CTol are superimposed on the road surface based on scheduled travel line PRL so that the right and left boundary lines are substantially equidistant from scheduled travel line PRL.

In detail, center content CTc allows boundary lines CTcr and CTcl to be superimposed on a position more distant from the right and left lane lines than those in the second embodiment, in other words, on a position near center portion Pc of subject vehicle lane Lns (see FIG. 36). The distance from each section line for each of boundary lines CTcr and CTcl is approximately equal to or is slightly longer than offset control amount Wos. Interval We between boundary lines CTcr and CTcl in the horizontal direction is approximately equal to or is slightly longer than vehicle width Wa of vehicle A. As illustrated in FIG. 36, interval Wc indicates the distance on the road surface in a state where the contents are projected onto the road surface in the foreground.

In the offset start display according to the fifth modification (see FIG. 37), both boundary lines CTor and CTol of offset content CTo curve in the direction to depart from the control target (large vehicle AL) while substantially maintaining interval Wc in the horizontal direction. Offset content CTo indicates that the offset control is provided for the entire display shape, not that interval We decreases in the horizontal direction. Boundary lines CTcr and CTcl of center content CTc are superimposed at a position distant from the lane lines. Therefore, boundary lines CTor and CTol of offset content CTo remain superimposed inside the lane line. Also in the offset stop display illustrated in FIG. 38, boundary lines CTor and CTol are superimposed on the section ranging from offset cancellation start position Po2 to offset end position Poe while maintaining interval We in the horizontal direction and curving toward the control target. Boundary lines CTor and CTol transition from center portion Pc (scheduled travel line PRL) to boundary lines CTcr and CTcl of center content CTc while being superimposed on the road surface at the position to ensure equal interval.

The above-described embodiments and modifications use the travel scenes as examples to explain the information representation. The HCU can represent the information related to the lane keeping control in travel scenes different from the above.

For example, a scene illustrated in FIG. 39 includes adjacent lane Lna on the right and left of subject vehicle lane Lns. Suppose each adjacent lane Lna includes large vehicle AL as a control target for the offset control. Then, the lane keeping control unit continuously provides the offset control to depart from these control targets. In such a travel scene, the display generation unit 76 according to the first embodiment alternately displays mutually continuous center content CTc and offset content CTo to represent scheduled travel line PRL.

A scene illustrated in FIG. 40 also includes adjacent lane Lna on the right and left of subject vehicle lane Lns. Large vehicle AL as a control target for the offset control travels each adjacent lane Lna. Suppose vehicle A travels to pass between the right and left control targets. Then, the lane keeping control unit provides the right and left control target regions and generates scheduled travel line PRL to travel center portion Pc on subject vehicle lane Lns.

In the above-described travel scene, the display generation unit 76 according to the second embodiment assumes right boundary lines CTor and left boundary line CTol to be specific boundary lines CTos. The display generation unit 76 displays right and left specific boundary lines CTos in a curved shape that curves along the inside of the control target regions, based on the region shape information acquired by the vehicle information acquisition unit 72. The lane keeping control unit configures the horizontal interval between the control target regions to be wider than vehicle width Wa of vehicle A. Therefore, from the driver's viewpoint, interval Wo between specific boundary lines CTos also appears wider than vehicle width Wa of the subject vehicle.

The right and left specific boundary lines CTos can emphasize the provision of center keeping control and noticeably inform the driver that vehicle A is positioned at center portion Pc of subject vehicle lane Lns. As a result, it is possible to give a sense of reassurance to the driver.

The lane keeping control unit according to sixth and seventh modifications of the above-described embodiments determines priorities of control targets for the offset control. Specifically, as illustrated in FIG. 41, the lane keeping control unit according to the sixth modification selects the right or left control target whichever is given a higher priority (risk). The lane keeping control unit provides the offset control in the direction to separate from the high-priority control target. For example, the lane keeping control unit provides the offset control in the direction to separate from pedestrian Pe by configuring the priority of pedestrian Pe moving on sidewalk Sw to be higher than the priority of large vehicle AL on adjacent lane Lna.

Suppose a travel scene where control targets for the offset control exist on the right and left of vehicle A. Then, the vehicle information acquisition unit 72 recognizes priorities of the right and left control targets based on the information acquired from the lane keeping control unit. Based on the information acquired from the vehicle information acquisition unit, the display generation unit 76 assumes left boundary line CTol closer to the high-priority control target (pedestrian Pe) to be specific boundary line CTos out of right boundary line CTor and left boundary line CTol. Namely, the display generation unit 76 offsets only right boundary line CTor or left boundary line CTol, whichever is closer to the high-priority control target.

Specifically, the display generation unit 76 displays offset content CTo with specific boundary line CTos curved along the control target region to keep a predetermined offset distance Wol (such as 30 cm to 1 m) from sidewalk Sw where pedestrian Pe exists. The sixth modification also ensures horizontal interval Wo between boundary lines CTor and CTol to be wider than vehicle width Wa of vehicle A in terms of the driver's viewpoint and the state of projection onto the foreground.

As illustrated in FIG. 42, the lane keeping control unit according to the seventh modification allows a distance from the high-priority control target (pedestrian Pe) to be longer than a distance from the low-priority control target (large vehicle AL) in terms of the right and left control targets. For example, the distance from the high-risk control target is ensured approximately twice as long as the distance from the low-risk control target.

According to the seventh modification, the vehicle information acquisition unit 72 also recognizes priorities of the right and left control targets based on the information acquired from the lane keeping control unit in a travel scene where control targets for the offset control exist on the right and left of vehicle A. The display generation unit 76 assumes right boundary line CTor and left boundary line CTol to be specific boundary line CTos and curves boundary lines CTor and CTol into offset shapes to avoid the right and left control target regions. The display generation unit 76 allows offset distance Wol for left boundary line CTol to be longer than offset distance Wor for right boundary line CTor because left boundary line CTol is close to the high-priority control target. This offset content CTo also ensures horizontal interval Wo between boundary lines CTor and CTol to be wider than vehicle width Wa of vehicle A in terms of the driver's viewpoint and the state of projection onto the foreground. In the seventh modification, offset distances Wol and Wor are comparable to “offset widths.”

There may be offset control targets on the right and left of subject vehicle lane Lns. Then, the lane keeping control unit according to an eighth modification of the above-described embodiments provides speed management to decelerate vehicle A. In such a travel scene, the vehicle information acquisition unit 72 acquires deceleration control information about the speed management. As illustrated in FIG. 43, the display generation unit 76 superimposes deceleration content CTd on the road surface of a deceleration section capable of activating the deceleration control according to the speed management, based on the deceleration control information acquired by the vehicle information acquisition unit 72. Deceleration content CTd is displayed in a mode different from center content CTc and is superimposed on center portion Pc of subject vehicle lane Lns similar to center content CTc. For example, deceleration content CTd is superimposedly displayed as a broken line shape. When offset content CTo includes two boundary lines CTor and CTol, the display mode is changed for boundary line CTor or CTol, whichever is superimposed on the road surface of the deceleration section.

It may be favorable to accordingly change the shapes of the offset contents illustrated in the above-described embodiments and modifications. For example, boundary lines may be drawn thinner than those of the above-described embodiments and may be shaped to extend linearly along a scheduled travel line. The offset content may be drawn in a shape that fills the travelable range recognized by the lane keeping control unit on the road surface of the subject vehicle lane. Instead of the lane line, contents such as boundary lines may be superimposed on the road surface at positions from roadway edges, for example.

The contents may be changed as appropriate in terms of static elements such as display color, display brightness, display shape, and display size, and dynamic elements such as the presence or absence of blinking, the cycle of blinking, the presence or absence of animation, and the animation motion, for example. The offset content may be deformed by increasing a horizontal variation in comparison with scheduled travel line PRL to emphasize an occurrence of the horizontal movement.

The traveling position of vehicle A under the center keeping control provided by the lane keeping control unit need not exactly correspond to the center of the subject vehicle lane in the width direction. The traveling position of vehicle A under the center keeping control may be shifted to the right or the left from the center of the geometric subject vehicle lane based on the user's settings, for example. Center portion Pc as the offset control reference may be provided as a center point of the geometric subject vehicle lane or as a control reference point used for the center keeping control.

The lane keeping control unit according to a ninth modification of the above-described embodiments differs from the embodiments in the data format of the line shape information supplied to the HCU. The line shape information according to the above-described embodiments can specify shapes of scheduled travel line PRL based on the coordinate information about major points, the distance between points, and the curvature radius, for example. Contrastingly, the line shape information according to the ninth modification contains many pieces of coordinate information. Each coordinate information represents points placed on scheduled travel line PRL at predetermined intervals. The ninth modification also enables the HCU to restore the shape of scheduled travel line PRL based on many pieces of coordinate information.

A tenth modification of the above-described embodiments also provides the HCU with results of recognizing control targets for the offset control. According to the tenth modification, the display generation unit recognizes analysis results such as the relative position, relative moving speed, and size of the control target, for example. Using these recognition results, the display control unit may display a content that emphasizes the control target or does not interfere with the visibility of the control target.

The HCU according to the above-described embodiments uses the position information detected by DSM at the eyepoint to successively control projection shapes and positions of the virtual image light to be imaged as a superimposition content so that the superimposition content is fittingly superimposed on the superimposition target when viewed from the driver. However, the HCU according to an eleventh modification of the above-described embodiments does not use the DSM-detected information but uses setup information centered at a predetermined reference eyepoint to control projection shapes and positions of the virtual image light to be imaged as the superimposition content.

The projector 21 of the HUD 20 according to a twelfth modification includes an EL (Electro Luminescence) panel instead of the LCD panel and the backlight. Furthermore, the HUD 20 can include a projector using a display instrument such as a plasma display panel, a cathode ray tube, or LED instead of the EL panel.

The HUD 20 according to a thirteenth modification includes a laser module (LSM) and a screen instead of the LCD and the backlight. The LSM includes a laser light source and a MEMS (Micro Electro Mechanical Systems) scanner, for example. The screen uses a micromirror array or a microlens array, for example. Such an HUD draws display images on the screen by scanning the laser beam irradiated from the LSM. The HUD uses a magnifying optical element to project the display images, drawn on the screen, onto the windshield and thereby displays virtual images Vi in the air.

The HUD 20 according to an fourteenth modification includes a DLP (Digital Light Processing, registered trademark) projector. The DLP projector includes a digital mirror device (DMD) provided with many micromirrors as well as a projection light source to project the light toward the DMD. The DLP projector draws display images on the screen under the control of cooperation between the DMD and the projection light source.

The HUD 20 according to a fifteenth modification includes a projector that uses LCOS (Liquid Crystal On Silicon). The HUD according to a sixteenth modification uses a holographic optical element as one of the optical systems to display virtual images VI in the air.

A seventeenth modification of the above-described embodiments equips vehicle A with only one of the driving assistance ECU 50 and the automated driving ECU 52. The onboard system need not be provided with multiple lane keeping control units. An eighteenth modification of the above-described embodiments equips vehicle A with the driving assistance ECU 50 and the automated driving ECU 52 as one onboard ECU.

A nineteenth modification of the above-described embodiments integrally configures the HCU and the HUD. That is, the control circuit of the HUD according to the nineteenth modification includes the processing function of the HCU. In the nineteenth modification, the HUD is comparable to a “display control device.” Further, a meter ECU, a navigation ECU, and a display audio ECU may include the processing function of the HCU. According to this modification, a meter, a navigation system, and a display audio instrument are comparable to the “display control devices.”

In the above-described embodiments, the functions provided by the HCU are available as software and hardware to implement the software, software only, hardware only, or multiple combinations thereof. When the functions are provided by an electronic circuit as hardware, the functions can also be provided by a digital circuit or an analog circuit including many logic circuits.

It may be favorable to appropriately change the form of a storage medium that stores a program, for example, capable of implementing the above-described display control method. The storage medium is not limited to the configuration of installation on a circuit board. For example, the storage medium may be provided in the form of a memory card, for example, inserted into a slot, and electrically connected to the control circuit of the HCU. Further, the storage medium may be available as an optical disk or a hard disk drive as a source of copying the program to the HCU.

The HMI system may be mounted on vehicles including not only private vehicles but also hired vehicles, manned taxicabs, ride-sharing vehicles, freight vehicles, and buses. The HMI system and the HCU may be mounted on vehicles dedicated to unattended operations used for Mobility as a Service.

The HMI system may be mounted on right-hand-drive vehicles or left-hand-drive vehicles. The traffic environment for vehicle traveling may presuppose the left-hand traffic or the right-hand traffic. The lane keeping control and the related indications according to the present disclosure are appropriately optimized in compliance with the traffic laws of respective countries and regions, and the steering wheel positions of vehicles, for example.

Specifically, the above-described embodiments and modifications presuppose the traffic rules for right-hand-drive vehicles and left-hand traffic. Basically, the large vehicle is assumed to travel a climbing lane (or driving lane) on the left. The subject vehicle is assumed to overtake the large vehicle by traveling an overtaking lane on the right. However, based on the traffic rules for right-hand traffic, the indications according to the present disclosure may be applied to a scene in which the subject vehicle traveling an overtaking lane on the left overtakes large vehicle AL traveling a climbing lane on the right. In this case, the displays are provided by reversing the right and left in the displays described in the above-described embodiments and modifications.

The control unit and the method thereof described in the present disclosure may be provided by a dedicated computer configuring a processor that is programmed to perform one or more functions embodied by a computer program. Alternatively, the apparatus and the method thereof described in the present disclosure may be provided by a dedicated hardware logic circuit. Moreover, the apparatus and the method thereof described in the present disclosure may be provided by one or more dedicated computers configured by a combination of a processor to execute computer programs and one or more hardware logic circuits. The computer programs as instructions executed by the computer may be stored in a non-transitory tangible computer-readable storage medium.

What is claimed is:

1. A display control device for a vehicle to control display on a head-up display, the display control device comprising:
an information acquisition unit that, from a lane keeping control unit controlling the vehicle to travel within a subject vehicle lane on which the vehicle travels, acquires offset information about an offset control to move a traveling position from a center portion of the subject vehicle lane to one of right and left sides; and
a display control unit that, based on the offset information, superimposedly displays an offset content indicating fulfillment of the offset control on a road surface in a foreground.

2. The display control device according to claim 1,
wherein the display control unit uses the offset content to display an estimated trace along which the offset control schedules the vehicle to travel.

3. The display control device according to claim 2,
wherein the display control unit secures the estimated trace represented by the offset content to a content settled at a specific timing.

4. The display control device according to claim 1,
wherein the display control unit superimposedly displays a center content on the road surface, the center content indicating that the lane keeping control unit controls the traveling position to the center portion.

5. The display control device according to claim 1,
wherein the display control unit displays an announcement content to announce the fulfillment of the offset control when a start position of the offset control in the foreground is located outside an angle of view of the head-up display.

6. The display control device according to claim 1,
wherein the offset content is superimposed, in a linear or belt form, on a future traveling position on the road surface where the lane keeping control unit schedules the vehicle to travel.

7. The display control device according to claim 1,
wherein the offset content includes a right boundary line and a left boundary line extending along a right lane line and a left lane line of the subject vehicle lane, respectively.

8. The display control device according to claim 7,
wherein the offset content indicates the fulfillment of the offset control by means of a reduction of a horizontal interval between the right boundary line and the left boundary line.

9. The display control device according to claim 7,
wherein a horizontal interval between the right boundary line and the left boundary line is wider than a vehicle width of the vehicle.

10. The display control device according to claim 7,
wherein, when control targets for the offset control exist on both a right side and a left side of the subject vehicle lane, the information acquisition unit recognizes priorities of the control targets on the right and left sides; and
wherein the display control unit allows an offset width of one of the right boundary line and the left boundary line close to one of the control targets having a higher priority to be larger than an offset width of the other of the right boundary line and the left boundary line.

11. The display control device according to claim 7,
wherein, when control targets for the offset control exist on both a right side and a left side of the subject vehicle lane, the information acquisition unit recognizes priorities of the control targets on the right and left sides; and
wherein the display control unit offsets only one of the right boundary line and the left boundary line closer to one of the control targets having a higher priority.

12. The display control device according to claim 1, wherein
wherein the display control unit initiates a transition display from an offset announcement display to an offset start display, when a start position of the offset control in the foreground enters an angle of view of the head-up display, and
wherein the display control unit transforms a specific boundary line of the transition display from a straight line to a crank shape and allows a tip portion of the specific boundary line in a traveling direction of the vehicle to approach an announcement content displayed by the offset announcement display, the specific boundary line extending along one of a right section line and a left section line of the subject vehicle lane being closer to a control target of the offset control.

13. The display control device according to claim 1,
wherein the offset content includes a right boundary line and a left boundary line extending along a right section line and a left section line of the subject vehicle lane, respectively, and
wherein, in a state where the right boundary line and the left boundary line are projected on the road surface, a horizontal distance between the right boundary line and the left boundary line in a right and left direction on the road surface reduces in a traveling direction of the vehicle.

14. The display control device according to claim 1,
wherein the offset content includes a specific boundary line that extends along a specific section line, the specific section line being one of a right section line and a left section line of the subject vehicle lane being closer to a control target of the offset control, and
wherein the display control unit displays the specific boundary line so that an outer edge of the specific boundary line on a side further from the control target than an outer edge of the specific boundary line closer to the control target separates from the specific section line in a traveling direction of the vehicle from a start position of the offset control.

15. The display control device according to claim 1,
wherein the offset content includes a specific boundary line that extends along a specific section line, the specific section line being one of a right section line and a left section line of the subject vehicle lane being closer to a control target of the offset control, and
wherein the display control unit displays the specific boundary line so that an outer edge of the specific boundary line on a side further from the control target than an outer edge of the specific boundary line closer to the control target approaches the specific section line in a traveling direction from a cancellation start position of the offset control.

16. The display control device according to claim 1,
wherein the display control unit limits a superimposition range of the offset content to a position on the road surface closer to the vehicle than an end position of the offset control in an offset stop display to notify an end of the offset control.

17. The display control device according to claim 1,
wherein, when control targets for the offset control exist on both a right side and a left side of the subject vehicle lane, the information acquisition unit recognizes priorities of the control targets on the right side and the left side, and
wherein the display control unit displays the offset content so as to separate from one of the control targets having a higher priority.

18. A non-transitory computer-readable storage medium which stores program instructions for controlling a head-up display of a vehicle, the program instructions configured to cause one or more processors to:
acquire, from a lane keeping control unit controlling the vehicle to travel within a subject vehicle lane, offset information about an offset control to move a traveling position from a center portion of the subject vehicle lane to one of right and left sides; and
superimposedly display an offset content indicating fulfillment of the offset control on a road surface in a foreground based on the offset information.

19. The non-transitory computer-readable storage medium according to claim 18,
wherein the program instructions are configured to further cause the one or more processors to:
display an announcement content to announce the fulfillment of the offset control when a start position of the offset control in the foreground is located outside an angle of view of the head-up display.

20. The non-transitory computer-readable storage medium according to claim 18,
wherein the offset content includes a right boundary line and a left boundary line extending along a right lane line and a left lane line of the subject vehicle lane, respectively,
wherein the program instructions are configured to further cause the one or more processors to:
recognize priorities of control targets for the offset control, when the control targets exist on both a right side and a left side of the subject vehicle lane; and
allow an offset width of one of the right boundary line and the left boundary line close to one of the control targets having a higher priority to be larger than an offset width of the other of the right boundary line and the left boundary line.

21. The non-transitory computer-readable storage medium according to claim 18,
wherein the offset content includes a right boundary line and a left boundary line extending along a right lane line and a left lane line of the subject vehicle lane, respectively,
wherein the program instructions are configured to further cause the one or more processors to:
recognize priorities of control targets for the offset control, when the control targets exist on both a right side and a left side of the subject vehicle lane; and
offset only one of the right boundary line and the left boundary line,
whichever is close to one of the control targets having a higher priority.

22. The non-transitory computer-readable storage medium according to claim 18,
wherein the program instructions are configured to further cause the one or more processors to:
initiate a transition display from an offset announcement display to an offset start display, when a start position of the offset control in the foreground enters an angle of view of the head-up display, and
transform a specific boundary line of the transition display from a straight line to a crank shape while allowing a tip portion of the specific boundary line in a traveling direction of the vehicle to approach an announcement content displayed by the offset announcement display, the specific boundary line extending along one of a right section line and a left section line of the subject vehicle lane being closer to a control target of the offset control.

23. The non-transitory computer-readable storage medium according to claim 18,
wherein the offset content includes a right boundary line and a left boundary line extending along a right section line and a left section line of the subject vehicle lane, respectively, and
wherein, in a state where the right boundary line and the left boundary line are projected on the road surface, a horizontal distance between the right boundary line and the left boundary line in a right and left direction on the road surface reduces in a traveling direction of the vehicle.

24. The non-transitory computer-readable storage medium according to claim 18,
wherein the offset content includes a specific boundary line that extends along a specific section line, the specific section line being one of a right section line and a left section line of the subject vehicle lane being closer to a control target of the offset control, and
wherein the program instructions are configured to further cause the one or more processors to:
display the specific boundary line so that an outer edge of the specific boundary line on a side further from the control target than an outer edge of the specific boundary line closer to the control target separates from the specific section line in a traveling direction of the vehicle from a start position of the offset control.

25. The non-transitory computer-readable storage medium according to claim 18,
wherein the offset content includes a specific boundary line that extends along a specific section line, the specific section line being one of a right section line and a left section line of the subject vehicle lane being closer to a control target of the offset control, and
wherein the program instructions are configured to further cause the one or more processors to:
display the specific boundary line so that an outer edge of the specific boundary line on a side further from the control target than an outer edge of the specific boundary line closer to the control target approaches the specific section line in a traveling direction from a cancellation start position of the offset control.

26. The non-transitory computer-readable storage medium according to claim 18,
wherein the program instructions are configured to further cause the one or more processors to:
limit a superimposition range of the offset content to a position on the road surface closer to the vehicle than an end position of the offset control in an offset stop display to notify an end of the offset control.

27. The non-transitory computer-readable storage medium according to claim 18,
wherein the program instructions are configured to further cause the one or more processors to:
recognize, when control targets for the offset control exist on both a right side and a left side of the subject vehicle lane, priorities of the control targets on the right side and the left side, and
display the offset content so as to separate from one of the control targets having a higher priority.
